(19) United States
(12) Patent Application Publication
(10) Pub. No.: US 2006/0159233 A1
(43) Pub. Date: Jul. 20, 2006

(54) Re-arrangeable analog electrical cross connect

(76) Inventors: John Michael Cotton, Rochester, NY (US); Robert Alan Macaluso, Webster, NY (US); Perlis Joseph Trahan, Ontario, NY (US)

Correspondence Address: MORGAN & FINNEGAN, L.L.P., 3 World Financial Center, New York, NY, 10281-2101, US

(21) Appl. No.: 11/039,131

(22) Filed: Jan. 19, 2005

(51) Int. Cl. H04M 3/08; H04M 11/00

(52) U.S. Cl. 379/22; 379/100.01

(57) ABSTRACT

A solid-state electronic switching system is disclosed. The switching system may be used to provide re-arrangeable analog electrical cross connections between telephone lines from a telephone company's central office and telephone lines that lead to subscribers' homes. The central office may reallocate services, without dispatching a technician, by issuing re-arrangement commands that reconfigure the analog electrical cross connections in the switching system. The switching system has been designed so that it may be used to interconnect telephone lines on which analog telephone services are provided.

### BACKGROUND OF THE INVENTION

Traditional land line telephone networks are based on a hierarchy of Central Office (“CO”) switches. A local switch is the lowest member of the switching hierarchy. Telephone subscribers are connected to a local switch by subscriber lines. Various members of the switching hierarchy are interconnected by trunk lines.

During the early years, subscriber lines were brought into a local switch directly by copper wires and connected to line circuits by means of a copper-interconnect frame, also referred to as a “main frame.” There is also a similar copper-interconnect frame that is referred to as a “secondary interconnect frame,” which connects inter-office trunk lines to trunk circuits.

The purpose of these interconnect frames was to provide a simple means for reallocating a subscriber line or trunk line to a service circuit. Reallocation is required in the event of: a change in subscriber connection; a change in service offering; a change in trunk provisioning; a failure of equipment; or an upgrade of equipment.

With increased penetration of telephony, an introduction of facsimile service requiring multiple lines per subscriber, and high costs associated with installing more copper lines, a method of making more efficient use of existing copper lines to accommodate increased connections was developed, called SLC 96. As this is a Lucent term, the generic term Digital Loop Carrier (“DLC”) will be used. DLCs were installed in local communities of interest to concentrate groups of up to 96 subscribers over five existing copper connections to a Central Office using Pulse Code Modulation (“PCM”). However, for all the reasons given above, a local distribution frame was required to connect line circuits of a DLC to local subscriber lines. This circuitry and distribution frame combination is housed in a curbside cabinet, which is referred to as a “pedestal.” Subsequently, with the advent of the Internet and a desire for higher bandwidth connections to subscribers, a pedestal was also used to provide Digital Subscriber Loop (“DSL”) connections to a subscriber over the subscriber's existing local copper connection.

In all existing instances of distribution frames, a copper cross connect is manually installed, and when required manually modified. With Central Office main frames, continual modification of connections has lead to a build up of no longer used copper wires, so that later modifications become increasingly difficult and labor intensive. With pedestals, each change requires a dispatch of a technician and his van to a pedestal site. Often, more than one dispatch is required because of manual errors made by technicians. Thus, pedestal maintenance is costly and operating companies are looking for ways to reduce this cost. Any technique to achieve a cost reduction for pedestals might also be used to reduce costs for Central Office main frames.

With recent advances in compression and transmission coding techniques, it will become possible to offer television service over subscriber line connections in the near future. This will provide a further complication to managing pedestal cross connects and a further justification for the installation of a remotely controlled version.

One important feature of an analog phone line is battery supply from a Central Office or a pedestal, which allows continued communication in emergency situations that cause loss of power to a neighborhood. Continuing to provide battery supply service in addition to TV service is a further challenge to copper cross connect design.

### SUMMARY OF THE INVENTION

It is therefore an objective of this invention to develop a switching system to provide a pedestal cross connect by electronic circuits that may be controlled from a Central Office or other remote site, which will much reduce or even eliminate a need for constant labor-intensive manual modification.

A further objective of this invention is to overcome problems inherent in introducing a low voltage analog cross connect into a voice path between a Central Office and subscribers.

Another objective of this invention is to provide a reliable mechanism to control many remote cross connects from a computer terminal in a Central Office or other remote site.

Another objective of this invention is to require a one-time installation of electronic circuits to replace an existing cross connection distribution frame in a pedestal.

Still another objective of this invention is to provide failure resilience that will allow any unavoidable manual intervention to be delayed until normal working hours, and thus minimize labor costs.

Yet another objective of this invention is to define a basic switch structure that will minimize costs while offering failure resilience

### BRIEF DESCRIPTION OF DRAWINGS

A more complete understanding of the present invention may be had by reference to the following Detailed Description with the accompanying drawings, wherein:

FIG. 1A is a block diagram depicting a prior art Copper-interconnect Frame, which is used to couple a Copper Cable that supplies fully analog service from a Central Office to Subscriber Lines.

FIG. 1B is a block diagram depicting a Re-Arrangeable Analog Electrical Cross Connect of the present invention, which is used to couple a Copper Cable that supplies fully analog service from a Central Office to Subscriber Lines.

FIG. 2A is a block diagram depicting a prior art Copper-Interconnect Frame, which is used to couple a DSL Cable and a PCM Cable, which supply digital services from a Central Office, to Subscriber Lines.

FIG. 2B is a block diagram depicting a Re-Arrangeable Analog Electrical Cross Connect of the present invention, which is used to couple a DSL Cable and a PCM Cable, which supply digital services from a Central Office, to Subscriber Lines.

FIG. 3 is a block diagram depicting a high-level overview of a Re-Arrangeable Analog Electrical Cross Connect of the present invention.

FIG. 4 is a block diagram showing an In Matrix Access Group and Switching Plane structure of a re-Arrangeable Analog Electrical Cross Connect of the present invention.

FIG. 5 is a block diagram showing one In Matrix Access Group and Switching Plane structure for a one unit system of a Re-Arrangeable Analog Electrical Cross Connect of the present invention.

FIG. 6 is a block diagram showing one Switching Plane of an In Matrix for a Four Unit System of the present invention.

FIG. 7 is a block diagram showing connection paths through a Re-Arrangeable Analog Electrical Cross Connect of the present invention.

FIG. 8 is a block diagram showing a Subscriber Line Circuit Access Block of the present invention.

FIG. 9 is a block diagram showing a Trunk Line Circuit Access Block of the present invention.

FIG. 10 is a block diagram showing control mechanisms for an interconnect Plane Switching Card of the present invention.

FIG. 11 is a block diagram showing control mechanisms for an interconnect Access Group Card of the present invention.

FIG. 12 is a block diagram showing a control interconnection pattern for a One Unit System of the present invention.

FIG. 13 is a block diagram showing a response interconnection pattern for a One Unit System of the present invention.

FIG. 14 is a block diagram showing dual path cable throw connections using one embodiment of the present invention.

FIG. 15 is a block diagram showing overall system control flow of the present invention.

### DETAILED DESCRIPTION OF THE DRAWINGS

Analog Connections

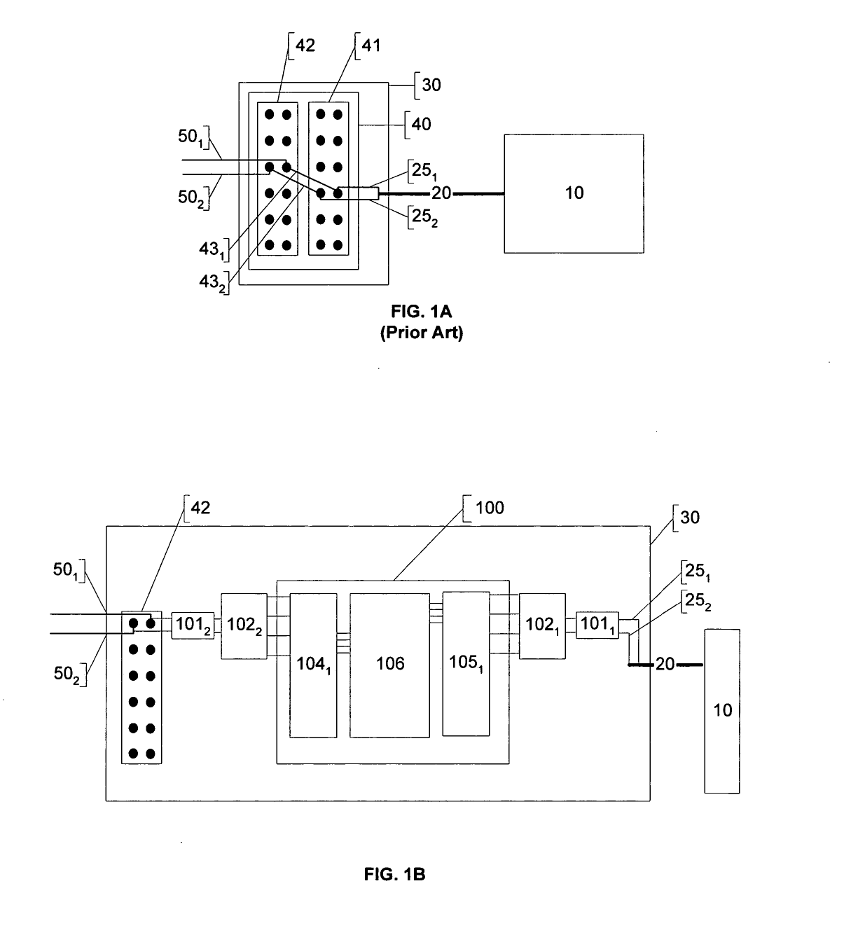

FIG. 1A shows a prior art method of interconnecting copper wires that are used to support fully analog telephone service. A Central Office 10 is connected to a Copper Cable 20 that contains a plurality of Copper Wires, of which only Copper Wires 25₁ and 25₂ are shown. Copper Wires 25₁ and 25₂ form a twisted pair that is used to provide analog telephone service (not shown). Copper Cable 20 is also connected to a Pedestal 30, which houses a prior art Copper-Interconnect Frame 40.

Copper Wires 25₁ and 25₂ are each connected to a Central Office Interface 41 of the Copper-Interconnect Frame 40. Copper-Interconnect Frame 40 also has a Subscriber Interface 42, which is connected to a plurality of Subscriber Lines, of which only Subscriber Lines 50₁ and 50₂ are shown. A technician (not shown) manually places Copper Interconnection Wires 43₁ and 43₂ on terminals, which are represented as black dots of Central Office Interface 41 and Subscriber Interface 42. Copper Interconnection Wire 43₁ is used to interconnect Copper Wire 25₁ with Subscriber Line 50. Similarly, Copper Interconnection Wire 43₂ is used to interconnect Copper Wire 25₂ with Subscriber Line 50₂. In this regard, fully analog connections are established, which are communications paths that are used for analog phone service (not shown).

Many line circuit functions are required to support analog phone service in the Plain Old Telephone System (“POTS”). Battery feed (not shown) is supplied to Subscriber Lines 50₁ and 50₂ to power subscriber telephones (not shown). Over-voltage protection (not shown) protects subscriber telephones (not shown), equipment which is housed in Pedestal 30, and equipment (not shown) at Central Office 10 from power surges, which, for example, may be caused by lightning (not shown). Ringing provision (not shown) supplies ringing voltages (not shown) to Subscriber Lines 50₁ and 50₂, when incoming calls (not shown) are received at Central Office 10.

Supervision (not shown) refers to an ability to detect a state of a subscriber's telephone (not shown), which is either in an “on-hook” or an “off-hook” state. Coder and Decoder (“CODEC”) functions convert a format of a telecommunications signal (not shown). Hybrid functionality (not shown) is used to perform conversions between two-wire and four-wire lines. Test functionality (not shown) allows verification of a voice path (not shown) both towards and from Central Office 10.

Collectively, these line circuit functions are referred to as BORSCHT functions. Copper-Interconnect Frame 40 simply extends analog services (not shown) from Central Office 10, which is fully responsible for providing BORSCHT line circuit functions (not shown) for Subscriber Lines 50₁ and 50₂.

FIG. 1B shows a method of interconnecting copper wires, which are used to support fully analog connections, with a Re-Arrangeable Analog Electrical Cross Connect 100 of the present invention. A Central Office 10 is connected to a Copper Cable 20 that contains a plurality of Copper Wires, of which only Copper Wires 25₁ and 25₂ are shown. Copper Wires 25₁ and 25₂ form a twisted pair that is used to provide analog telephone service (not shown) from Central Office 10.

Copper Cable 20 is also connected to a Pedestal 30, which houses the Re-Arrangeable Analog Electrical Cross Connect 100, Protection Units, of which only Protection Units 101₁ and 101₂ are shown; Hybrid Units, of which only Hybrid Units 102₁ and 102₂ are shown; and Subscriber Interface 42. Re-Arrangeable Analog Electrical Cross Connect 100 contains Subscriber Line Circuit Access Blocks, of which only Subscriber Line Circuit Access Block 104₁ is shown; Trunk Line Circuit Access Blocks, of which only Trunk Line Circuit Access Block 105₁ is shown; and Interconnection Matrices 106.

Copper Wires 25₁ and 25₂ are connected to Protection Unit 101₁, which is also connected to a two-wire interface of Hybrid Unit 102₁. Hybrid Unit 102₁ converts the two-wire format of Copper Wires 25₁ and 25₂ into a four-wire format, which is connected to Trunk Line Circuit Access Block 105₁. Trunk Line Circuit Access Block 105₁ is connected to Interconnection Matrices 106, which provides connection paths (not shown) between Subscriber Line Circuit Access Block 104₁ and Trunk Line Circuit Access Block 1051.

For example, since Copper Wires 25₁ and 25₂ form a twisted pair, one wire is used for transmission and the other for reception of analog telephone signals (not shown). On the four-wire side of Hybrid Unit 102₁, there are two wires used for transmission, which consist of a signal wire and a ground wire, and similarly two wires used for reception of analog telephone signals. The signal wire that is used for transmission is connected to an In Matrix (not shown) of Interconnection Matrices 106. Similarly, the signal wire that is used for reception is connected to an Out Matrix (not shown) of Interconnection Matrices 106.

On the other side of Re-Arrangeable Analog Electrical Cross Connect 100, Subscriber Lines 50₁ and 50₂, which form a twisted pair, are connected to Subscriber Interface 42, which is connected to Protection Unit 101₂, which is also connected to a two-wire interface of Hybrid Unit 102₂. A four-wire interface of Hybrid Unit 102₂ is connected to Subscriber Line Circuit Access Block 104₁. The signal wire from Hybrid Unit 102₂, which is used for reception, is connected by Subscriber Line Circuit Access Block 104₁ to an Out Matrix (not shown) of Interconnection Matrices 106. Similarly, the signal wire from Hybrid Unit 102₂, which is used for transmission, is connected by Subscriber Line Circuit Access Block 104₁ to an In Matrix (not shown) of Interconnection Matrices 106. The various ground wires are connected to a ground plane.

Re-Arrangeable Analog Electrical Cross Connect 100 has previously received commands (not shown) that cause Subscriber Line Circuit Access Block 104₁, Trunk Line Circuit Access Block 105₁, and Interconnection Matrices 106 to enable interconnection paths (not shown), such that lines used for transmission on the Central Office 10 side of Re-Arrangeable Analog Electrical Cross Connect 100 are connected to lines used for reception on the Subscriber Line 50 side of Re-Arrangeable Analog Electrical Cross Connect 100. Similarly, the interconnection paths are such that lines used for reception on the Central Office 10 side of Re-Arrangeable Analog Electrical Cross Connect 100 are connected to lines used for transmission on the Subscriber Line 50 side of Re-Arrangeable Analog Electrical Cross Connect 100.

Protection Units 102 perform a variety of BORSCHT functions. For example, battery feed (not shown) from Central Office 10 is used to charge local batteries (not shown) and to provide battery feed (not shown) to Subscriber Lines 50. Over voltage protection (not shown) is provided on both sides of Re-Arrangeable Analog Electrical Cross Connect 100 by Protection Units 101. Ringing voltage (not shown) from Central Office 10 is detected and blocked from damaging Re-Arrangeable Analog Electrical Cross Connect 100. For example, Protection Unit 101₁, identifies a ringing voltage on Copper Wires 25₁ and 25₂, blocks the ringing voltage from entering Re-Arrangeable Analog Electrical Cross Connect 100, and instructs Protection Unit 101₂ to apply a ringing voltage to Subscriber Line 50₁. This functionality requires a form of signaling across Re-Arrangeable Analog Electrical Cross Connect 100, which is accomplished by applying a maximum voltage or an attenuated ringing voltage (not shown) across a forward path of Re-Arrangeable Analog Electrical Cross Connect 100, for example.

Protection Units perform supervisory functions, such as detecting off-hook signals (not shown) on Subscriber Lines. For example, off-hook signals (not shown) on Subscriber Line 50₂ are identified and forwarded by Protection Unit 101₂ across Re-Arrangeable Analog Electrical Cross Connect 100 and are relayed by Protection Unit 101₁ through Copper Cable 20 to Central Office 10. Protection Units also smooth contact bounce (not shown) in a way that allows subscribers (not shown) to use hook-flash signals (not shown) on Subscriber Lines to recall an exchange control (not shown) or an operator (not shown).

Re-Arrangeable Analog Electrical Cross Connect 100 contains four-wire cross connect matrices (not shown). For example, Hybrid Unit 101₂ converts Subscriber Lines 50₁-50₂, which are in a two-wire format, into a four-wire format, so that each signal wire of the four-wire format can be connected to Subscriber Line Circuit Access Block 104₁. For reliability purposes, Subscriber Lines 50₁-50₂ can have two appearances (not shown) within Subscriber Line Circuit Access Block 104₁. For example, a signal wire from Hybrid Unit 102₂, which is used for transmission on Subscriber Line 50₂, is connected to an input of a Switching Element (not shown) of Line Access Block 104₁, which connects the input to the In Matrix (not shown) of the Interconnection Matrices 106. The second appearance may be connected to another input of the Switching Element,(not shown) of Subscriber Line Circuit Access Block 104₁.

Digital Connections

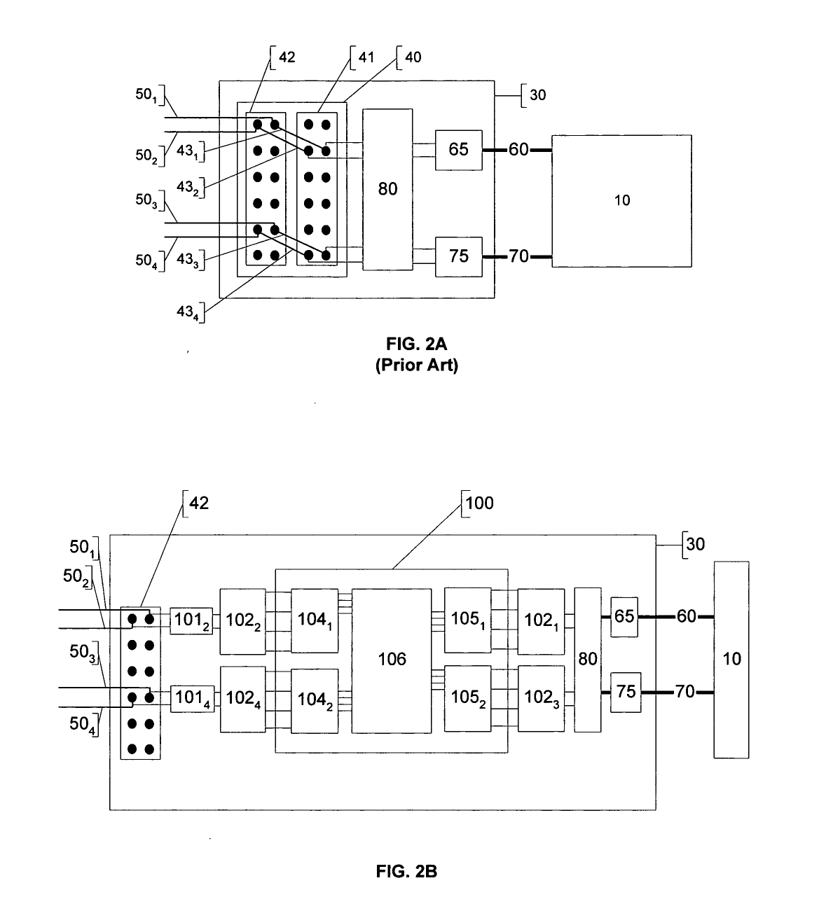

Reference is now made to FIGS. 2A and 2B. In addition to the above, several assumptions have been made. It is assumed that DSL service (not shown), where required, has not been merged with normal telephony service (not shown) at Central Office 10, but may be merged in the DLC line cards (not shown) of the DLC 80 or may be merged with the voice signals in the Re-Arrangeable Analog Electrical Cross Connect 100. It is also assumed that a DSL signal (not shown) carried by DSL Cable 60 is a low voltage signal, for example 5 volts, so as not to damage switching semiconductors (not shown) of Re-Arrangeable Analog Electrical Cross Connect 100. It is further assumed that DSL signals (not shown) are able to endure Re-Arrangeable Analog Electrical Cross Connect 100 causing additional degradation of the DSL signals beyond existing degradation due to traveling a distance from Central Office 10. Another assumption is that merging of television signals (not shown) at Central Office 10 is not done, because of a limited range that these signals have over Copper Wires. Thus, it is assumed that a television signal (not shown) will be merged at Pedestal 30 in the future.

FIG. 2A is a block diagram depicting a prior art Copper-interconnect Frame 40, which is used to interconnect DSL Cable 60 and PCM Cable 70 with Subscriber Lines 50₁-50₄. DSL service (not shown) is delivered from Central Office 10 over DSL Cable 60. PCM service (not shown) is delivered from Central Office 10 over PCM Cable 70.

DSL Cable 60 connects to DSL Protect Unit 65, which is also connected to DLC 80. Similarly, PCM Cable 70 connects to PCM Protect Unit 75, which is also connected to DLC 80. Lines circuits from DLC 80 are connected to Central Office Interface 41 of Copper-interconnect Frame 40, which also has a Subscriber Interface 42. As with analog connections that were described earlier, a technician (not shown) manually places Copper Interconnection Wires 43₁-43₄ to interconnect terminals, which are shown as black dots, of Central Office Interface 41 and Subscriber Interface 42.

FIG. 2B is a block diagram depicting a Re-Arrangeable Analog Electrical Cross Connect 100 of the present invention, which is used to interconnect DSL Cable 60 and PCM Cable 70 with Subscriber Lines 50₁-50₄. DSL service (not shown) is delivered from Central Office 10 over DSL Cable 60. PCM service (not shown) is delivered from Central Office 10 over PCM Cable 70.

DSL Cable 60 is connected to DSL Protect Unit 65, which is also connected to DLC 80. Similarly, PCM Cable 70 is connected to PCM Protect Unit 75, which is also connected to DLC 80. Line circuits from DLC 80 are connected to two-wire interfaces of Hybrid Units, of which only Hybrid Units 102₁ and 102₃ are shown connected to DLC 80. The four-wire interfaces of Hybrid Units 102₁ and 102₃ are connected to Trunk Line Circuit Access Blocks 105₁ and 105₂, respectively.

On the other side of Re-Arrangeable Analog Electrical Cross Connect 100, Subscriber Lines 50₁ and 50₂ are connected to Protection Unit 101₂, which is connected to a two-wire interface of Hybrid Unit 102₂. Similarly, Subscriber Lines 50₃ and 50₄ are connected to Protection Unit 101₄, which is connected to a two-wire interface of Hybrid Unit 102₄. Four-wire interfaces of Hybrid Units 102₂ and 102₄ are connected to Subscriber Line Circuit Access Blocks 104₁ and 104₂, respectively.

Trunk Line Circuit Access Blocks 105₁ and 105₂, and Subscriber Line Circuit Access Blocks 104₁ and 104₂ are interconnected by Interconnection Matrices 106. As with the previous example regarding FIG. 1B, Re-Arrangeable Analog Electrical Cross Connect 100 has previously received commands (not shown) instructing it to enable semiconductors (not shown) that are used to enable internal communications paths (not shown) that interconnect appropriate Subscriber Lines with appropriate line circuits from DLC 80, which are supplied by DSL Cable 60 and PCM Cable 70

In preferred embodiments, BORSCHT functions are provided as follows. Battery feed (not shown) is provided by DLC 80, but cannot be carried across Re-Arrangeable Analog Electrical Cross Connect 100, so battery feed must be managed. Pedestal 30 is supplied with Alternating Current (“AC”) power (not shown) and has a battery backup (not shown). These power facilities are used to provide battery feed (not shown) to Subscriber Lines 50₁-50₄. DSL Protect Unit 65 and PCM Protect Unit 75 provide over-voltage protection (not shown) on the Central Office 10 side of Pedestal 30. Additional over-voltage protection (not shown) is provided by Protect Units 101₂ and 101₄, which protect the semiconductors (not shown) of Re-Arrangeable Analog Electrical Cross Connect 100 from excessive voltages (not shown) that may exist on Subscriber Lines.

Semiconductors (not shown) of Re-Arrangeable Analog Electrical Cross Connect 100 cannot be exposed to ringing voltages (not shown), so ringing voltages from DLC 80 are detected and blocked or attenuated before traversing Re-Arrangeable Analog Electrical Cross Connect 100. A ringer circuit (not shown) is activated on the other side of Re-Arrangeable Analog Electrical Cross Connect 100 to supply ringing voltages to Subscriber Lines.

In order for supervisory functions (not shown) of DLC 80 to operate, battery signals (not shown) received on Subscriber Lines are replicated by Re-Arrangeable Analog Electrical Cross Connect 100. Coder and Decoder (“CODEC”) functions (not shown) continue to be done by DLC 80.

Design Assumptions and Requirements

The following general discussion is without specific reference to a particular figure. Preferred embodiments have been designed based on many assumptions that will be described briefly below. A ratio of subscribers to trunk lines will be 2:3, with two lines provided per subscriber. A multi-plane network provides necessary resilience within a network, without resorting to network duplication. To provide resilience there will be spare trunks available.

DSL service will be required for only 50% of subscriber lines. Switch semiconductor chips of a Re-Arrangeable Analog Electrical Cross Connect are able to provide a “one to many” connection, but not a “many to one” connection. Connections through switching elements of a Re-Arrangeable Analog Electrical Cross Connect are unidirectional.

Television service will not reach more than 33% of subscribers. Present quality TV can be delivered on a single twisted pair, whereas high definition digital TV (“HDTV”) will require two twisted pairs. It shall be possible to provide every subscriber with emergency Plain Old Telephone Service (“POTS”). TV signals and DSL service can share the same twisted pairs as POTS, since they occupy different regions of the spectrum. Up to 50% of subscribers may request a second POTS connection.

Preferred embodiments have been designed based on several fundamental requirements, which will be briefly described below. Preferred embodiments have been designed to: survive any single failure without interruption to service for more than one minute; offer a ninety-five percent probability of surviving any two independent failures; provide BORSCHT line circuit functions with minimum cost; utilize a number of switching elements closely approximating “n log n”, where n is the number of terminal ports; provide both DSL and TV connection paths which do not exceed acceptable degradation; ensure that existing subscriber connections do not lose service during re-routing activities; and be able to provide POTS service to every subscriber, regardless of whatever other service is provided.

System Overview

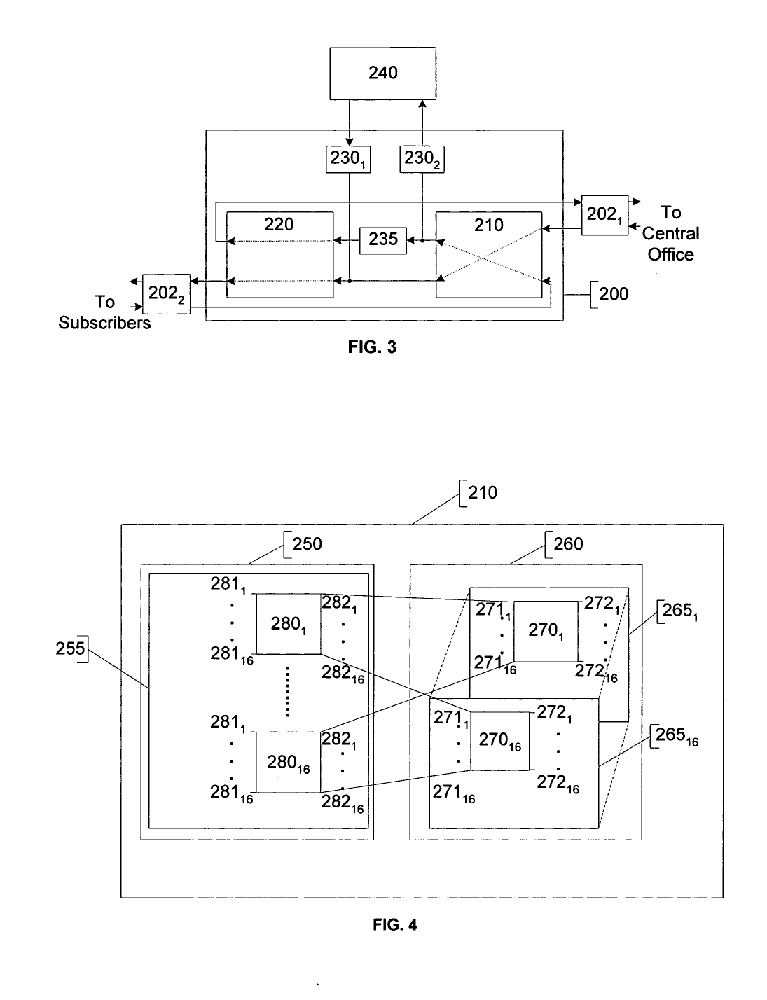

Referring now to FIG. 3, there is shown a high-level block diagram of an exemplary Re-Arrangeable Analog Electrical Cross Connect 200, which illustrates some principles that are common to other embodiments. Re-Arrangeable Analog Electrical Cross Connect 200 has two matrices, which include a forward or In Matrix 210 and a return or Out Matrix 220. In Matrix 210 and Out Matrix 220 each contain Subscriber Line Access Cards (not shown) and Trunk Line Access Cards (not shown) that are connected to a plurality of Hybrid Units, of which only Hybrid Units 202₁ and 202₂ are shown. In this example, Hybrid Unit 202₁ is also connected to trunk lines (not shown) that lead to a Central Office (not shown) and Hybrid Unit 202₂ is also connected to subscriber lines (not shown) that lead to subscribers' homes (not shown).

Re-Arrangeable Analog Electrical Cross Connect 200 may be configured to take a plurality of input signals (not shown), which are provided to a plurality of signal inputs (not shown) and combine them into a composite signal, which is provided to a single signal output. For example, Re-Arrangeable Analog Electrical Cross Connect 200 can be used to combine a voice signal component from a Central Office and a television signal component from a TV Server 240, so that the two signal components are provided as a composite signal to a single copper wire of a twisted pair (not shown) that is connected to a subscriber's home.

For signals leading to the subscriber's home, the voice signal component (not shown) from the Central Office is provided to a first input of the In Matrix 210, which provides a first analog electrical cross connection to a first output of the In Matrix 210. The first output of the In Matrix 210 is connected directly to a first input of the Out Matrix 220, which provides a second analog electrical cross connection to a first output of the Out Matrix 220. The television signal component (not shown) from the TV Server 240 is first provided to an input of a High Pass Filter 230₁, which minimizes degradation of the television signal component by blocking DC signal components and allowing transmission of only AC signal components. An output of the first High Pass Filter 230₁ is connected to the first input of the Out Matrix 220, which also receives the voice signal component that originated at the Central Office. The television signal component and voice signal component form a first composite signal and share the second analog electrical cross connection, which is provided by the Out Matrix 220, such that the first composite signal is provided to the Hybrid Unit 202₂, which provides the composite signal to a single subscribe line that leads to the subscriber's home.

Similar connections are made for a second composite signal that is provided by a subscriber line that comes from the subscriber's home. The second composite signal contains a voice signal component, which is destined for the Central Office, and a television selection command signal component, which is destined for the TV server 240. The second composite signal enters a second input of the In Matrix 210. The In Matrix 210 provides a third analog electrical cross connection to a second output of the In Matrix 210. There are two signal paths from the second output of the In Matrix 210; a first path leads to an input of another High Pass Filter 230₂ and a second path leads to an input of a Low Pass Filter 235. The television selection signal component (not shown) exits an output of the High Pass Filter 2302 and is provided to the TV Server 240. The voice signal component exits an output of the Low Pass Filer 235 and is provided to a second input of the Out Matrix 220. The Out Matrix 220 provides a fourth analog electrical cross connection to a second output of the Out Matrix 220 that is connected to the Hybrid Unit 2021, which is also connected to the Central Office.

It should be noted that similar connections can be made with other types of secondary signal sources. For example, the TV Server 240 could be replaced with a Digital Subscriber Line Access Multiplexer (not shown). In addition, regeneration and amplification of DSL or TV signals may be provided on the outputs of the Hybrid Unit 202₂.

It should also be noted that the In Matrix 210 and Out Matrix 220 employ diodes (not shown) that control directions of signal flows within each Matrix. The number of required Low Pass Filters 235 is reduced by the presence of these diodes. For example, the Output Port of the In Matrix 210 that outputs a voice signal component from the Central Office is connected to a signal merging point, which is also connected the output of the High Pass Filter 230₁ that outputs the television signal component. Diodes in the In Matrix 210 prevent the television signal component from entering this Output Port of the In Matrix 210. Thus, the Low Pass Filter 235 is only required for the voice signal component that is destined for the Central Office side of the Re-Arrangeable Analog Electrical Cross Connect 200. In this case, the Low Pass Filter 235 removes extraneous DSL or TV signal components that may interfere with proper functioning of Central Office equipment.

Access Groups and Switching Planes

FIG. 4 shows an exemplary In Matrix 210 of the present invention, which is part of a Re-Arrangeable Analog Electrical Cross Connect (not shown). In Matrix 210 is divided into an Access Section 250 and an Interconnection Section 260. Access Section 250 of this exemplary In Matrix 210 is comprised of a single Access Group 255, which contains sixteen Rank Zero Switching Elements 280₁-280₁₆. Each Rank Zero Switching Element has sixteen Input Ports 281₁-281₁₆ and sixteen Output Ports 282₁-282₁₆. Each Rank Zero Switching Element has unidirectional signal connection paths (not shown), which can be enabled by commands (not shown), that interconnect any signal Input Port 281 with any signal Output Port 282.

Input Ports 281₁-281₁₆ of each of the Rank Zero Switching Elements 280₁-280₁₆ are also called Access Ports, since they are used to provide access to Subscriber Lines (not shown) and Trunk Lines (not shown). Since there are sixteen Rank Zero Switching Elements 280₁-280₁₆, each of which has sixteen Input Ports 281₁-281₁₆, a single Access Group 255 provides a total of 256 Access Ports.

Interconnection Section 260 is comprised of sixteen Switching Planes 265, of which only Switching Planes 265₁ and 265₁₆ are shown. The structure of each of the Switching Planes 265 is identical. Each Switching Plane 265 has a Rank One Switching Element 270, which has sixteen Input Ports 271₁-271₁₆ and sixteen Output Ports 272₁-272₁₆, which may be connected as input to an Out Matrix (not shown), or as input to Rank Two switches (not shown) if a larger matrix is to be assembled. In general, a port on an interface between an In Matrix and an Out Matrix is referred to as an Inner Matrix Port, which also provides access to TV signals (not shown).

Each of the Rank Zero Switching Elements of Access Group 255 has an Output Port connected to an Input Port of each of Rank One Switching Elements, on each of the Switching Planes. For Example, Switching Element 280₁ has one of its Output Ports 282₁-282₁₆ connected to Input Port 271₁ of each of the Rank One Switching Elements 270₁-270₁₆, respectively. Similarly, Rank Zero Switching Element 280₁₆ has one of its Output Ports 282₁-282₁₆ connected to Input Port 271₁₆ of each of the Rank One Switching Elements 270₁-270₁₆, respectively. Once traffic (not shown) enters a Switching Plane it may not have access to any other Switching Plane. TV traffic (not shown) enters a Switching Plane of an Out Matrix (not shown) through an Inner Matrix Port (not shown).

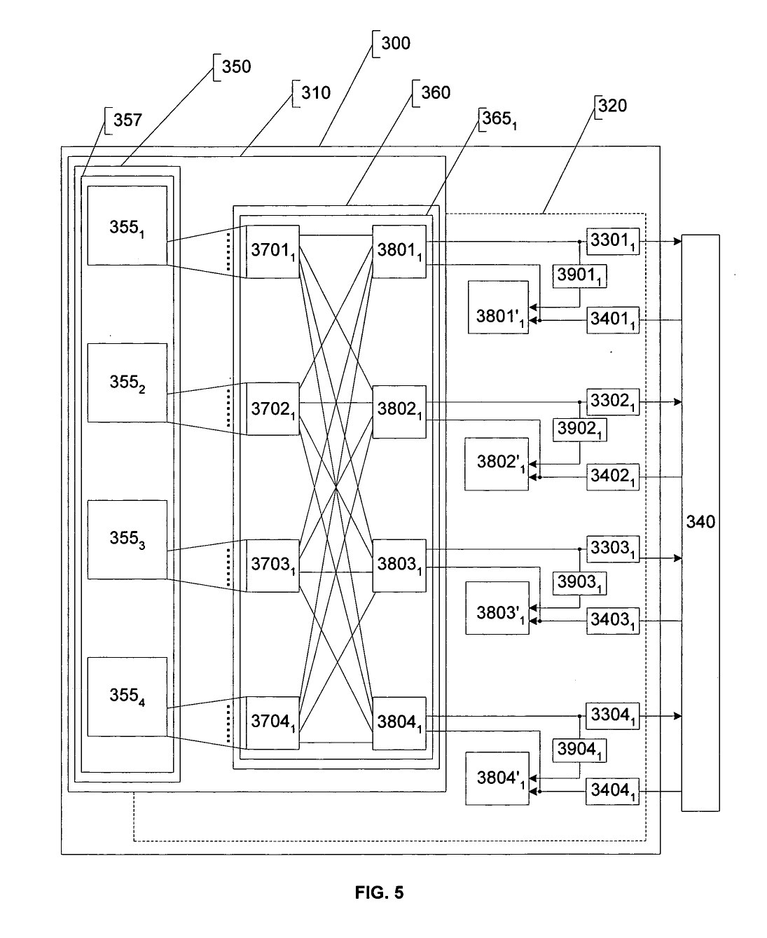

FIG. 5 depicts a block diagram of In Matrix Access Groups 355₁-355₄ and Switching Planes 365₁ of another embodiment of a Re-Arrangeable Analog Electrical Cross Connect 300 of the present invention, which will be referred to as a One Unit System. Re-Arrangeable Analog Electrical Cross Connect 300 has an In Matrix 310 and an Out Matrix 320. In Matrix 310 is divided into an Access Section 350 and an Interconnection Section 360. Access Section 350 contains a single Unit 357 that is comprised of four Access Groups 355₁-355₄, each of which is arranged similarly to Access Group 255 of FIG. 4. Interconnection Section 360 is comprised of sixteen identical Switching Planes 365₁-365₁₆, of which only Switching Plane 365₁ is shown.

Switching Plane 365₁ contains four Rank One Switching Elements 3701₁-3704₁ and four Rank Two Switching Elements 3801₁-3804₁. Each of the Access Groups 355₁-355₄ in Access Section 350 has sixteen of its Output Ports (not shown) connected to sixteen Input Ports (not shown) of one of the Rank One Switching Elements 3701₁-3704₁ on each of the Switching Planes 365₁-365₁₆. For example, Access Group 355₁ has sixteen of its two-hundred-fifty-six Output Ports (not shown) connected to sixteen Input Ports (not shown) of Rank One Switching Elements 3701₁ on each of the sixteen Switching Planes 365₁-365₁₆.

On each of the Switching Planes 365₁-365₁₆, each of the Rank One Switching Elements 3701₁-3704₁ has four Output Ports (not shown) connected to four Input Ports (not shown) of each Rank Two Switching Elements 3801₁-3804₁. For example, Output Ports 1-4 (not shown) of Rank One Switching Element 3701₁ are connected to Input Ports 1-4 (not shown) of Rank Two Switching Element 3801₁; Output Ports 5-8 (not shown) of Rank One Switching Element 3701₁ are connected to Input Ports 1-4 (not shown) of Rank Two Switching Element 3802₁; Output Ports 9-12 (not shown) of Rank One Switching Element 3701₁ are connected to Input Ports 1-4 (not shown) of Rank Two Switching Element 3803₁; and Output Ports 13-16 (not shown) of Rank One Switching Element 3701₁ are connected to input ports 1-4 (not shown) of Rank Two Switching Element 3804₁.

Similarly, Output Ports 1-4 (not shown) of Rank One Switching Element 3702₁ are connected to Input Ports 5-8 (not shown) of Rank Two Switching Elements 3801₁; Output Ports 5-8 (not shown) of Rank One Switching Element 3702₁ are connected to Input Ports 5-8 (not shown) of Rank Two Switching Element 3802₁; Output Ports 9-12 (not shown) of Rank One Switching Element 3702₁ are connected to Input Ports 5-8 (not shown) of Rank Two Switching Element 3803₁; and Output Ports 13-16 (not shown) of Rank One Switching Element 3702₁ are connected to Input Ports 5-8 (not shown) of Rank Two Switching Element 3804₁.

The Output Ports of Rank Two Switching Elements 3801₁-3804₁ of the In Matrix 310 are ultimately connected to corresponding Input Ports of Rank Two Switching Elements 3801′₁-3804′₁ of the Out Matrix 320. However, additional connections are required for secondary signal sources and destinations, such as TV Server 340.

For example, an Output Port of the Rank Two Switching Element 3801₁, which outputs a composite signal, has two connections. The first connection is to an input of a Low Pass Filter 3901₁, the output of which is connected to an Input Port of the Rank Two Switching Element 3801′₁. The second connection is to an input of a High Pass Filter 3301₁, the output of which is connected to an input of the TV Server 340. An output of the TV Server 340 provides a television signal to an input of another High Pass Filter 3401₁, the output of which is connected to an input of the Rank Two Switching Element 3801′₁, which is also connected to another Output Port of the Rank Two Switching Element 3801₁.

It should be noted that mounting sixteen Switching Elements on a single card (not shown) provides for very convenient packaging. One card (not shown) is required for each of the Access Groups 355₁-355₄, so four cards (not shown) are required for all of the Access Groups 355₁-355₄. Each of the Switching Planes 365₁-365₁₆ contains four Rank One Switching Element 3701₁-3704₁and four Rank Two Switching Elements 3801₁-3804₄, for a total of eight switching elements per Switching Plane. Thus, each of the Switching Elements 3701₁-3701₁₆ can be housed on a single card (not shown), so a total of eight cards (not shown) are required for all of the Switching Planes 365₁-365₁₆. Therefore, In Matrix 310 requires a total of twelve cards (not shown). Similarly, Out Matrix 320 requires a total of twelve cards (not shown) for switching traffic in the other direction. Consequently, Re-Arrangeable Analog Electrical Cross Connect 300 requires a total of twenty-four cards (not shown), which contain a total of 384 Switching Elements (not shown) for voice path switching and a further twenty-four Switching Elements (not shown) for control functions, which will be discussed below.

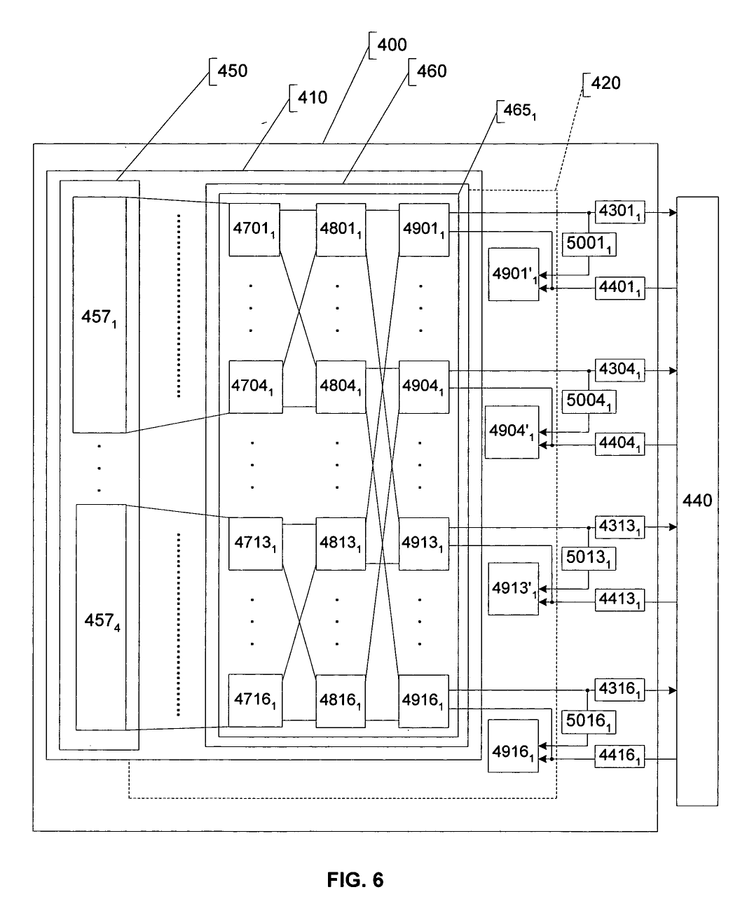

FIG. 6 depicts a high-level block diagram of another embodiment of a Re-Arrangeable Analog Electrical Cross Connect 400 of the present invention, which will also be referred to as a Four Unit System. Re-Arrangeable Analog Electrical Cross Connect 400 has an In Matrix 410 and an Out Matrix 420. In Matrix 410 is divided into an Access Section 450 and an Interconnection Section 460. Access Section 450 contains four Units 457₁-457₄, which are each arranged similarly to Unit 357 of FIG. 5. That is, Units 457₁-457₄ are each comprised of four Access Groups (not shown).

Interconnection Section 460 is comprised of sixteen identical Switching Planes 465₁-465₁₆, of which only Switching Plane 465₁ is shown. Each Switching Plane contains sixteen Rank One Switching Elements 4701₁-4716₁, sixteen Rank Two Switching Elements 4801₁-4816₁, and sixteen Rank Three Switching Elements 4901₁-4916₁.

Each of the four Access Groups (not shown) of each the Units 457₁-457₄, has sixteen of its two-hundred-fifty-six Output Ports (not shown) connected to sixteen Input Ports (not shown) of four of the sixteen Rank One Switching Elements on each of the Switching Planes. For example, each of the four Access Groups (not shown) of Unit 457₁ has sixteen of its two-hundred-fifty-six Output Ports (not shown) connected to Input Ports (not shown) of each of the Rank One Switching Element 4701₁-4704₁ on each of the Switching Planes 465₁-465₁₆. Similarly, each of the four Access Groups (not shown) of Unit 457₄ has sixteen Output Ports (not shown) connected to each of the Input Ports (not shown) of each of the Rank One Switching Elements 4713₁₃-4716₁ on each of the Switching Planes 465₁-465₁₆.

On each of the Switching Planes 465₁-465₁₆, each of the Rank One Switching Elements 4701₁-4716₁ has Output Ports (not shown) connected to Input Ports (not shown) of four of the sixteen Rank Two Switching Elements 4801₁-4816₁. For example, Rank One Switching Element 4701₁ has Output Ports 1-4 (not shown) connected to Input Ports 1-4 (not shown) of Rank Two Switching Element 4801₁; Output Ports 5-8 (not shown) connected to Input Ports 1-4 (not shown) of Rank Two Switching Element 4802₁ (not shown); Output Ports 9-12 (not shown) connected to Input Ports 1-4 (not shown) of Rank Two Switching Element 4803₁ (not shown); and Output Ports 13-16 (not shown) connected to Input Ports 1-4 (not shown) of Rank Two Switching Element 4804₁.

Similarly, Rank One Switching Element 4701₁ has Output Ports 1-4 (not shown) connected to Input Ports 13-16 (not shown) of Rank Two Switching Element 4801₁; output ports 5-8 (not shown) connected to Input Ports 13-16 (not shown) of Rank Two Switching Element 4802₁ (not shown); Output Ports 9-12 (not shown) connected to Input Ports 13-16 (not shown) of Rank Two Switching Element 4803₁ (not shown); and Output Ports 13-16 (not shown) connected to Input Ports 13-16 (not shown) of Rank Two Switching Element 4804₁.

Each of the Rank Two Switching Elements 4801₁-4816₁ has four Output Ports (not shown) connected to four Input Ports (not shown) of four of the sixteen Rank Three Switching Elements 4901₁-4916₁. For example, Rank Two Switching Element 4801₁ has Output Ports 1-4 connected to Input Ports 1-4 (not shown) of Rank Three Switching Elements 4901₁; Output Ports 5-8 (not shown) are connected to Input Ports 1-4 (not shown) of Rank Three Switching Elements 4905₁ (not shown); Output Ports 9-12 (not shown) are connected to Input Ports 1-4 (not shown) of Rank Three Switching Elements 4909₁ (not shown); and Output Ports 13-16 (not shown) are connected to Input Ports 1-4 (not shown) of Rank Three Switching Element 4913₁.

Similarly, Rank Two Switching Element 4804₁ has Output Ports 1-4 (not shown) connected to Input Ports 1-4 (not shown) of Rank Three Switching Element 4904₁; Output Ports 5-8 (not shown) are connected to Input Ports 1-4 (not shown) of Rank Three Switching Element 4908₁ (not shown); Output Ports 9-12 (not shown) are connected to input Ports 1-4 (not shown) of Rank Three Switching Element 4912₁ (not shown); and Output Ports 13-16 (not shown) connected to Input Ports 1-4 (not shown) of Rank Three Switching Element 4916₁.

The Output Ports of the Rank Three Switching Elements 4901₁-4916₁ of the In Matrix 410 are ultimately connected to corresponding Input Ports of corresponding Rank Three Switching Elements 4901′₁-4916′₁ of the Out Matrix 420. However, additional connections are required for secondary signal sources and destinations, such as TV Server 440.

For example, an Output Port of the Rank Three Switching Element 4901₁, which outputs a composite signal, has two connections. The first connection is to an input of a Low Pass Filter 5001₁, the output of which is connected to an Input Port of the Rank Three Switching Element 4901′₁. The second connection is to an input of a High Pass Filter 4301₁, the output of which is connected to an input of the TV Server 440. An output of the TV Server 440 provides a television signal to an input of another High Pass Filter 4401₁, the output of which is connected to an input of the Rank Three Switching Element 4901′₁, which is also connected to another Output Port of the Rank Three Switching Element 4901₁.

The Rank Three Switching Elements 4901₁-4916₁ are used for switching the traffic (not shown) from the four Units 457₁-457₄. As described, the Rank Three Switching Elements 4901₁-4916₁ are connected by four links (partially shown) to each of the corresponding Rank Two Switching Elements 4801₁-4816₁. An Eight Unit system (not shown) doubles the number of Rank Three Switching Elements (not shown) to thirty-two and uses two links (not shown) between corresponding Rank Two Switching Elements (not shown). Similarly, a Sixteen Unit system (not shown), which supports thirty-three DLC systems (not shown), doubles the numbers of Rank Three Switching Elements (not shown) again to sixty-four, and uses single link interconnections (not shown) to corresponding Rank Two Switching Elements (not shown). Such a system would handle 4,800 lines.

However, it is not clear that full interconnection between all subscriber lines and any trunk line is necessary, and the use of sixteen Single Unit Systems would be satisfactory, and more economic, and would more easily be extended to larger sizes as required. For this reason the rest of the discussion will concentrate on a Single Unit System, as depicted in FIG. 5. The use of a multiplicity of 16 Unit systems is suitable for Central Office mainframe applications.

It should be clear, to a reader skilled in the art, that there are numerous additional possible embodiments of the Re-Arrangeable Analog Electrical Cross Connect not described here which conform to the basic requirement that once traffic enters a switch plane in a matrix it may not have access to any other switch plane of that matrix.

Subscribers Served

The following general discussion is without reference to a particular figure. Present day usage is to provide two lines on average per subscriber, of which one and one-half come from a DLC, so that each DLC only serves sixty-four subscribers. The remaining subscriber connections are for broadband or other services, and subscriber recovery in the event of line failure.

The following assumptions have been made. The number of subscribers served by a One Unit System is S. From the above requirement, the number of ports on a matrix to support subscribers lines and trunks will be the number of subscriber lines plus the number of DLC ports, which is 2S+3S/2=7S/2=1024. Therefore, the maximum number of subscriber served is 292 and the maximum number of DLC ports, which are connected to DLC line circuits, is 438.

The number of subscribers requiring TV service, T, is estimated to be S/3, which seems reasonable because of competition from Cable and Satellite television service providers. Therefore, the number of subscribers requiring TV service is estimated to be 97.

The number of subscribers requiring IP telephony is estimated to be T/2=49. Each TV subscriber will require both subscriber lines, and in a worst case TV subscribers will require 2S/3=194 Inner Matrix Ports. The number of subscribers having at least one POTS line will be P=S−T/2=5S/6=242. The number of subscribers using a second POTS line for voice or FAX=P/2=5S/12=121.

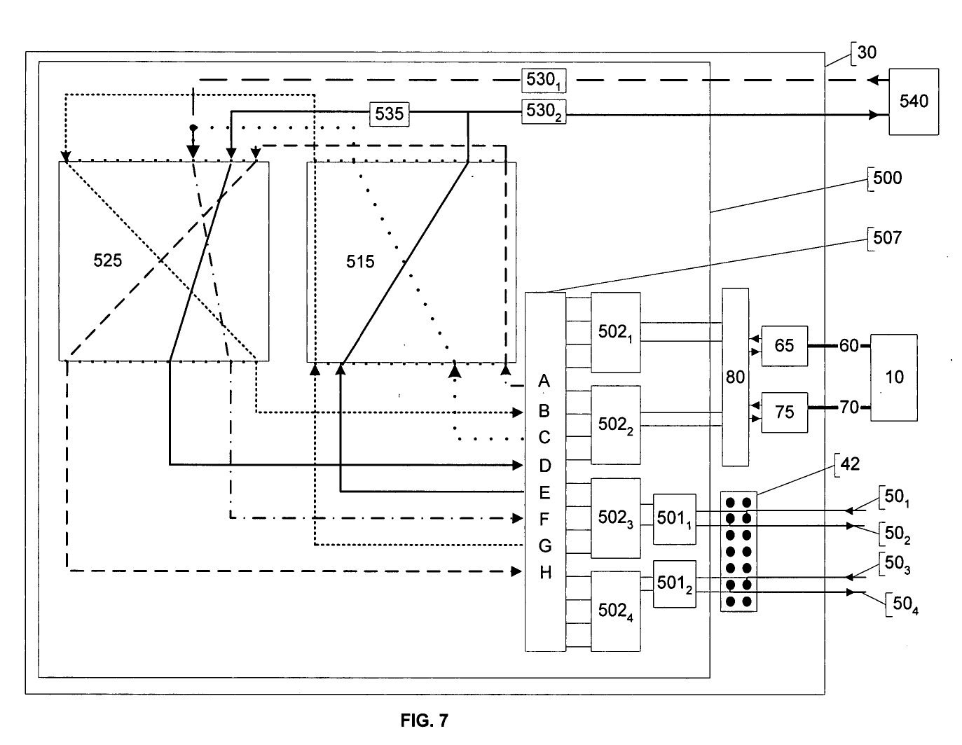

Referring now to FIG. 7, connection paths through a Re-Arrangeable Analog Electrical Cross Connect 500 of the present invention are shown. Pedestal 30 contains the Re-Arrangeable Analog Electrical Cross Connect 500, DSL Cable 60, DSL Protect Unit 65, PCM Cable 70, PCM Protect Unit 75, DLC 80, Hybrid Units 502₁-502₄, Protection Units 501₁-501₂, and Subscriber Interface 42, all of which are connected as previously discussed. Re-Arrangeable Analog Electrical Cross Connect 500 contains In Matrix Switching Planes 515, Out Matrix Switching Planes 525, and an Access Switch 507. Connection paths are shown inside Re-Arrangeable Analog Electrical Cross Connect 500 as a series of line segments that have similar markings.

For example, point A is connected to a Trunk Line Circuit Access Block (not shown) of the Access Switch 507. From point A a voice connection is interconnected with an Input Port of the In Matrix Switching Planes 515, which is depicted as a small square at the bottom of the In Matrix Switching Planes 515. The In Matrix Switching Planes 515 Switching provide an analog connection path to an Output Port, which is depicted as a small square at the top of the In Matrix Switching Planes 515. The connection path within the In Matrix Switching Planes 515 is figuratively depicted as a line segment that connects the Input Port with the Output Port. The voice path continues from the Output Port of the In Matrix Switching Planes 515 to an Input Port of Out Matrix Switching Planes 525, which is depicted as a small square at the top of the Out Matrix Switching Planes 525.

The voice path within the Out Matrix Switching Planes 525 is figuratively depicted as a line segment that connects the Input Port with an Output Port, which is depicted as a small square at the bottom of the Out Matrix Switching Planes 525. The voice path from point A continues from the Output Port to a point labeled H on the Access Switch 507, where a Subscriber Line Circuit Access Block (not shown) completes the voice path to one of the Subscriber Lines, such as Subscriber Line 50₄. From this example, it can be seen that each voice connection uses of two Inner Matrix Ports; that is one Output Port of In Matrix Switching Planes 515 and one Input Port of Out Matrix Switching Planes 525.

There is another voice connection starting at point G which is connected to a Subscriber Line Access Block (not shown) of the Access Switch 507. Beginning at point G the voice path continues to another Input Port of the In Matrix Switching Planes 515, which is connected to another Output Port at the top of the In Matrix Switching Planes 515. This voice connection path continues to another Input Port of the Out Matrix Switching Planes 525, which is connected to another Output Port of the Out Matrix Switching Planes 525. This voice path continues to point B which is connected to a Truck Line Access Block (not shown) of the Access Switch 507.

A composite voice plus television signal connection path is also depicted in FIG. 7. Starting at point C, which is connected to a Trunk Line Access Block.(not shown) of the Access Switch 507, a voice signal component that is ultimately from the Central Office 10 enters an Input Port of In Matrix Switching Planes 515, where it is switched to an Output Port, at the top of the In Matrix Switching Planes 515. The path internal to the In Matrix Switching Planes 515 is depicted as a line segment connecting Input and Output Ports. The voice path continues from the Output Port of In Matrix Switching Planes 515 to an Input Port of the Out Matrix Switching Planes 525, which is also connected to an output of a High Pass Filter 530₁, the input of which is connected to an output of the TV Server 540. At this Input Port to the Output Matrix Switching Planes 525 the voice signal component and television signal component are merged into a composite signal that is switched to an Output Port of the Output Matrix Switching Planes 525 that is connected to point F which is connected to a Subscriber Line Access Block (not shown) of the Access Switch 507.

There is another composite voice plus television signal path beginning at point E on the Access Switch 507, where a Subscriber Line Circuit Access Block (not shown) completes a voice path to one of the Subscriber Lines 50. Point E is connected to another Input Port of the In Matrix Switching Planes 515, which is connected to another Output Port of the In Matrix Switching Planes 515, which has two connections. A first connection is made to an input of a High Pass Filter 530₂, the output of which is connected to a input of the TV Server 540; this path carries television selection commands from a subscriber to the TV Server 540. A second connection is made to an input of a Low Pass Filter 535, the output of which is connected to another Input Port of the Out Matrix Switching Planes 525, which has a connection to another Output Port of the Out Matrix Switching Planes 525. This Output Port of the Out Matrix Switching Planes 525 is connected to point D on the Access Switch 507, where a Trunk Line Circuit Access Block (not shown) connects the voice signal component to the DLC 80, which PCM encodes the voice signal component and transmits it to the Central Office 10. f

If HDTV is used, additional Inner Matrix Ports are required. Thus, Inner Matrix Ports are critical resources.

Port Allocation

The following general discussion is without specific reference to a particular figure. The number of subscribers requiring television service is T, and T×2=S/3×2=2S/3 for TV=194. From above, POTS usage is 2×(5S/6+5S/12)=15 S/6=730. Total IMP usage on an Out Matrix is S/3+15S/6=17S/6=827.However, if POTS is required for all subscribers, so P=S, then the total IMP usage on an Out Matrix is S/3+3S=10 S/3=973. Thus, based on the assumptions above, a 1 Unit Re-Arrangeable Analog Electrical Cross Connect will support 292 subscribers, and use 438 DLC line circuits, which would come from 5 DLC systems, leaving 42 DLC line circuits to support monitor and control functions. The number of DSL users does not affect this calculation, as they merely require a different type of DLC line circuit.

As noted above, the numbers of Inner Matrix Ports and Access Ports assigned to each service are awkward, and not conducive to easy design or control. Ideally, these numbers would be powers of two, or at least multiples of 16. Starting with the TV service, T=S/3, and the number of Inner Matrix Ports assigned for TV input is S/3 in addition to POTS. This number, based on the discussion above is approximately 194. The nearest multiple of 16 is 192, so T=96, and S=288. This leads to the need for 432 DLC line circuits, supplied by 5 DLC systems with 48 DLC lines available to support control and monitoring functions.

There are 1024 Inner Matrix Ports on an Out Matrix of a One Unit Re-Arrangeable Analog Electrical Cross Connect, of which 96 are assigned as for TV only connections, leaving 926 for voice connections. This assignment supports 464 simultaneous POTS calls. Thus, if all 288 subscribers require POTS, then 176 would be able to have a second POTS line, or only 61%. On the other hand, if all of the subscribers with TV service also used IP telephony, then all of the remaining 192 subscribers could have two POTS lines. Of course, some of the subscribers using DSL could also use IP for facsimile service.

The outcome of the above discussion is as follows. A One Unit switch supports 288 subscribers with 432 DLC line circuits. The 192 Inner Matrix Ports for TV connections on Out Matrix 320 are split twelve per plane, or three per Rank Two Switching Element 380. The positioning of these three within the sixteen Inner Matrix Ports per Rank Two Switching Element 380 is a matter of software design. The equivalent 96 Inner Matrix Ports on a corresponding In Matrix are left unconnected, until a use is found for them.

Access Groups

In principle, Access Groups remain as shown in FIG. 5, which only shows Access Groups 355₁-355₄ for In Matrix 310 and assumes that Out Matrix 320 has Access Groups 355′₁-355′₄ (not shown), which are the same as Access Groups 355₁-355₄ from a circuit point of view, only with the directions of signal flows reversed.

In order to provide loop back testing and connection verification for Subscriber Lines (not shown), it is necessary that connections between Subscriber Lines and an Access Group leading to In Matrix 310 and connections between Subscriber Lines and an Access Group leading from Out Matrix 320 are on the same switching card. It is then possible to provide a loop switch between the two parts of each line connection to achieve a loop back test.

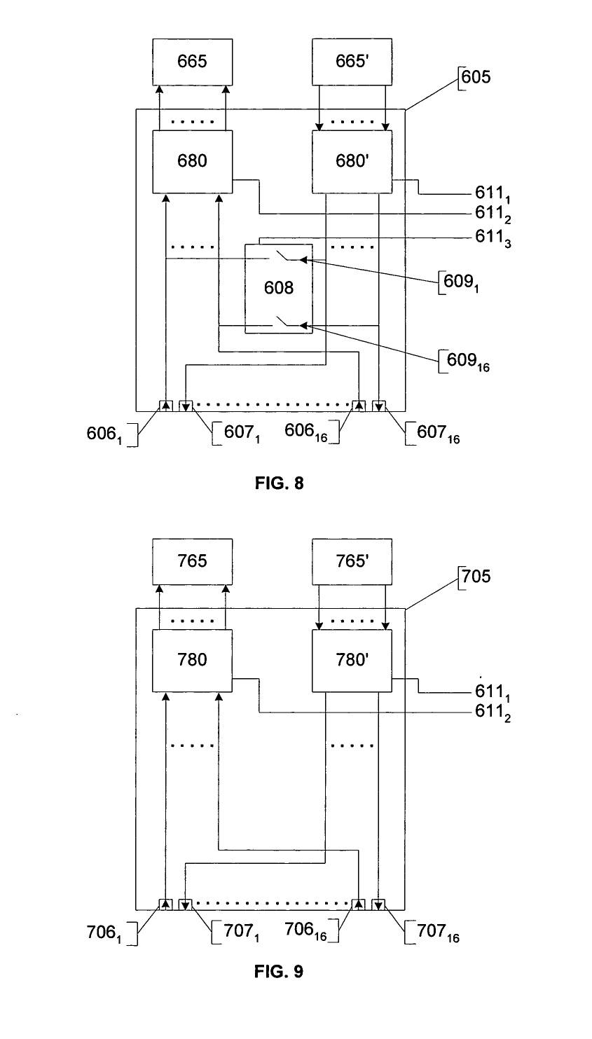

Referring now to FIG. 8, an exemplary Subscriber Line Circuit Access Block 605 is shown. Subscriber Line Circuit Access Block 605 has sixteen Input Ports, of which only Input Ports 606₁ and 606₁₆ are shown. Subscriber Lines (not shown) that are used for subscriber transmission are ultimately connected to Input Ports 606₁-606₁₆. Input Ports 606₁-606₁₆ are also connected to Input Ports (not shown) of Rank Zero Switching Element 680, whose Output Ports (not shown) are connected to Input Ports (not shown) of In Matrix Switching Planes 665. Subscriber Line Circuit Access Block 605 also has sixteen Output Ports, of which only Output Ports 607₁ and 607₁₆ are shown. Subscriber Lines (not shown) that are used for subscriber reception are ultimately connected to Output Ports 607₁-607₁₆. Output Ports 607₁-607₁₆ are also connected to Output Ports (not shown) of Rank Zero Switching Element 680′, whose Input Ports (not shown) are connected to Output Ports (not shown) of Out Matrix Switching Planes 665′.

Subscriber Line Circuit Access Block 605 contains a Loop Back Switch 608, which has sixteen Line Switches, of which only Line Switches 609₁ and 609₁₆ are shown. Line Switches are connected between pairs of Input Ports and Output Ports. A Line Switch of a particular line is “closed” during loop-back testing and is “open” under otherwise normal operation. Loop-back testing allows verification of a voice path both towards and from Subscriber Lines (not shown).

For example, Input Port 606₁ and Output Port 607₁ are ultimately connected to a twisted pair of subscriber lines (not shown). Input Port 606₁ is connected to a subscriber line (not shown) that carries voice signals (not shown) from a subscriber's premises (not shown). Out Port 607₁ is connected to the other subscriber line (not shown) that carries voice signals (not shown) to the subscriber's premises (not shown). When a loop back test is performed on the switch path connection to the subscriber's lines, Line Switch 609₁ receives an appropriate control signal (not shown) on a Control Line 611₃, which causes Line Switch 609₁ to change from an “open” state to a “closed” state. A loop back signal (not shown) is then sent from the trunk line (not shown) that is connected through the Out Matrix Switching Planes 665′ and thence to the output port of Rank Zero Switching Element 680′. After coming out of Rank Zero Switching Element 680′, the loop back signal, travels through Line Switch 609₁ to an Input Port (not shown) of Rank Zero Switching Element 680, which causes the loop back signal to return to its originator (not shown), thereby verifying the connection through the matrix switch (not shown).

Referring now to FIG. 9, an exemplary Trunk Line Circuit Access Block 705 is shown. Trunk Line Circuit Access Block 705 has sixteen Input Ports, of which only Input Ports 706₁ and 706₁₆ are shown. Trunk Lines (not shown) that are used to carry voice signals (not shown) away from a Central Office (not shown) are ultimately connected to Input Ports 706₁-706₁₆. Input Ports 706₁-706₁₆ are also connected to Input Ports (not shown) of Rank Zero Switching Element 780, whose Output Ports (not shown) are connected to In Matrix Switching Planes 765. Trunk Line Circuit Access Block 705 also has sixteen Output Ports, of which only Output Ports 707₁ and 707₁₆ are shown. Trunk Lines (not shown) that are used to carry voice signals (not shown) to a Central Office (not shown) are ultimately connected to Output Ports 707₁-707₁₆. Output Ports 707₁-707₁₆ are also connected to Output Ports (not shown) of Rank Zero Switching Element 780′, whose Input Ports (not shown) are connected to Output Ports (not shown) of Out Matrix Switching Planes 765′.

It may be observed that the only difference between a Trunk Line Circuit Access Block 705 and a Subscriber Line Circuit Access Block 605 is an addition of the Loop Back Switch 608 and corresponding connections to Input Ports 606 and Output Ports 607. Thus, the same card layout will serve for both, with the Loop Back Switch 608 function for Trunk Lines (not shown), either not used or even not equipped.

Concepts related to Access Group 255 were shown in FIG. 4. An Access Group 255 has 256 Output Ports (not shown), which are distributed between Subscriber Lines (not shown) and Trunk Lines (not shown), using sixteen Rank Zero Switching Elements, each with sixteen Input Ports. As previously discussed, the ratio of subscriber lines to trunk lines in such an Access Group 255 is 128 Subscriber Lines to 96 Trunk Lines. From the considerations above, it is clear that Access Group 255 serves a combination of 128 subscriber lines circuits and trunk line circuits, again in the ratio of 128 lines to 96 trunks. This approximates to 74 line circuits and 54 trunk circuits. Since these numbers do not partition conveniently into sets of sixteen, one of the Subscriber Line Circuit Access Blocks 605 of FIG. 8 will support a combination of ten subscriber line circuits (not shown) and six trunk lines circuits (not shown), with six of the Line Switches unused.

Principles of Control

In order to meet the reliability requirements outlined above, the following principles have been followed in devising a control structure. Reliability is paramount because the equipment is remote and unattended, whereas switching speed is of no consequence, as connections are likely to be changed no more than once a day.

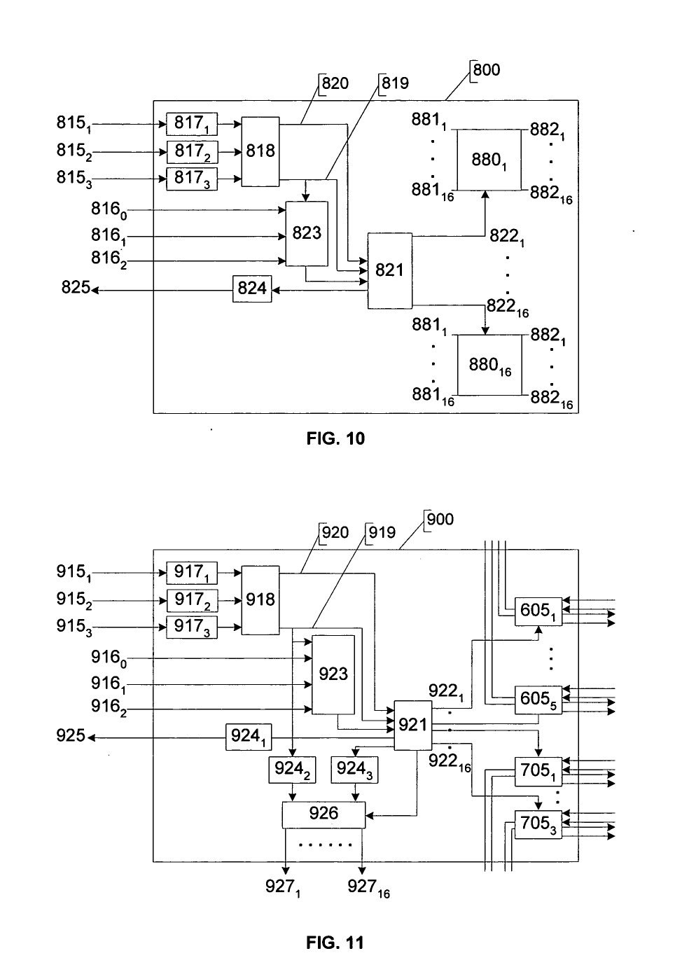

Referring now to FIG. 10, there is shown a control mechanism for a Plane Switching Card 800, which is used to connect paths within each of the sixteen Switching Planes (not shown). As was previously noted, it is convenient to mount one Switching Element from the same Group and Rank in each of the sixteen Switching Planes (not shown) on the same Plane Switching Card 800. The circuit layout principle for such a Plane Switching Card 800, along with its control is shown in FIG. 10. A Controller 821 uses Routing Control Outputs 822₁-822₁₆ to control sixteen Switching Elements 880₁-880₁₆, respectively. Controller 821 uses Routing Control Outputs 822₁-822₁₆ to transmit a revised control pattern (not shown) to Switching Elements 880₁-880₁₆, whenever a routing change is required.

Control Signals (not shown) from a Central Office (not shown) are comprised of existing telephony tone signals (not shown), which are able to traverse a DLC (not shown) and a Re-Arrangeable Analog Electrical Cross Connect (not shown). Further, there are commercially available chips (not shown) for generation and detection of these tone signals. Plane Switching Card 800 has three Control Inputs 815₁-815₃, through which Control Signals (not shown) are received. Control Inputs 815₁-815₃ are connected to inputs of Tone Decoders 817₁-817₃, respectively. Outputs of Tone Decoders 817₁-817₃ are used as input to a Voting Circuit 818, which implements a two-thirds majority voting mechanism (not shown).

Voting Circuit 818 has two outputs, Majority Output 819 and Minority Output 820, which are connected as input to Controller 821. A value of a majority of a two-thirds vote is supplied to the Controller 821 and a Matching Circuit 823 via Majority Output 819. If there is a discrepancy among Input Sources 815₁-815₃, the Controller 821 receives an indication via Minority Output 820. Controller 821 uses Tone Encoder 824 to pass values of Majority Output 819 and the fact of the occurrence of a Minority Output 820 back to the Central Office (not shown) through a Control Response Output 825, so that a control sequence may be verified as being correct.

Plane Switching Card 800 also has three Rank Inputs 816₀-816₂, which are used to assign a rank position the Plane Switching Card 800. For example, when an active voltage is applied to Rank Input 816₁ and Rank Inputs 816₀ and 816₂ are grounded, Plane Switching Card 800 is a rank one plane switching card. Response Inputs 816₀-816₂ lead into the Matching Circuit 823, which compares Response Inputs 816₀-816₂ and Majority Output 819. The result of the comparison is input to the Controller 821.

When reconfiguration is required in Plane Switching Card 800, Control Signals (not shown) are received on Control Inputs 815₁-815₃, which are decoded by Tone Decoders 817₁-817₃. Output from Tone Decoders 817₁-817₃ are input into Voting Circuit 818, which outputs the results on Majority Output 819 and Minority Output 820 to Controller 821.

Referring now to FIG. 11, there is shown a control mechanism for an Access Group Card 900, which is used to interconnect an Access Group (not shown) with Subscriber Lines (not shown) and Trunk Lines (not shown). A comparison of Access Group Card 900 and with Plane Switching Card 800 of FIG. 10 shows only minor differences. Direction of signal flows is one such difference. Another difference is that Access Group Card 900, has an additional Switching element chip, which is used as a Control Message Router 926 for routing control messages (not shown) to Rank I and 2 Matrix Cards (not shown), which are sent using Routing Control Outputs, of which only Routing Control Outputs 927₁ and 927₁₆ are shown.

A Controller 921 transmits the result of a majority two-thirds input vote to subsequent Plane Switching Cards (not shown) in the network, which are under the direction of the Controller 921. The outputs of Message Router 926 on Access Switching Card 900 are used in pairs, which are logically “or-ed” together, so that either can be used to forward an input signal. This provides a level of redundancy in the event of a failure.

Controller 921 uses Routing Control Outputs 922₁-922₁₆ to control Switching Elements (not shown) of Subscriber Line Circuit Access Blocks 605₁-605₅ and Trunk Line Circuit Access Blocks 705₁-705₃, and five Loop Switches (not shown) on Access Group Card 900. Thus, a single card design for Access Groups, when sub-equipped, without the Loop Switches and Control Message Router 926, will serve for all switching positions in a system. The direction of signal flow is purely a question of design of an interconnecting backplane (not shown).

If we consider the design of Access Groups 355₁-355₄ as shown in FIG. 5, it is clear that an Access Group Card 900 must have half of its interconnection paths connected to the In Matrix 310 and the other half connected to the Out Matrix 320. Thus, two Access Group Cards 900, which will be referred to as Access Group Card 900_{A} and Access Group Card 900_{B} are required for connection paths between In Matrix 310 and Out Matrix 320.

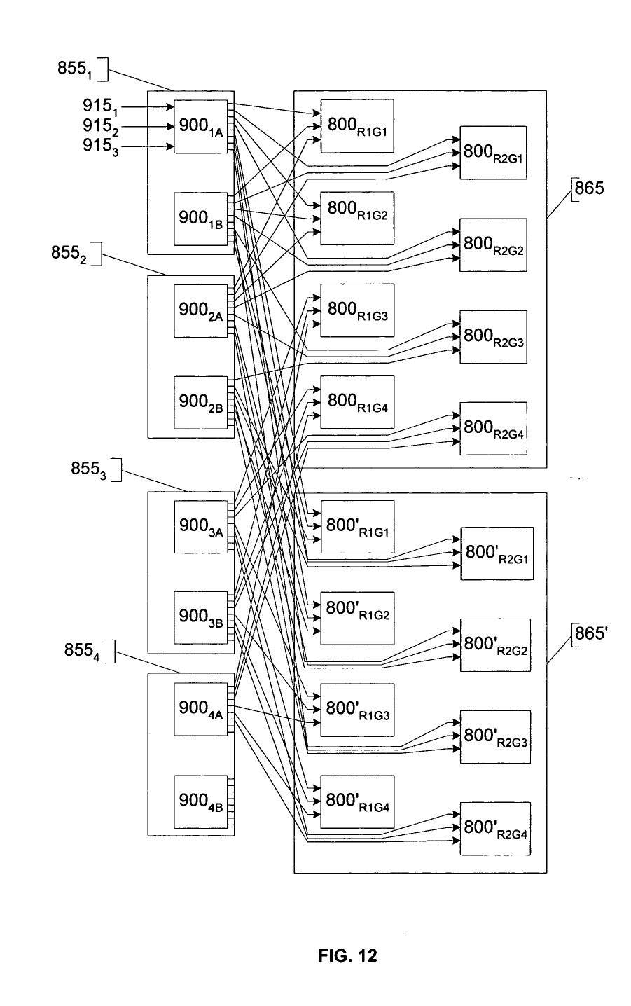

Referring now to FIG. 12, there is shown a Control Interconnection PatteRN for the One Unit Matrix of FIG. 5. A first group of Access Group Cards 900_{1A}, 900_{1B}, 900_{2A}, and 900_{2B} are used to interconnect traffic (not shown) between Access Groups 855₁ and 855₂ and In Matrix Switching Planes 865, and also between Access Groups 855₁ and 855₂ and Out Matrix Switching Planes 865′. A second group of Access Group Cards 900_{3A}, 900_{3B}, 900_{4A}, and 900_{4B} is used to interconnect traffic (not shown) between Access Groups 855₃ and 855₄ and In Matrix Switching Planes 865, and also between Access Groups 855₃ and 855₄ and Out Matrix Switching Planes 865′.

Each of the Access Group Cards 900 has three Control Inputs 915, of which only Control Inputs 915₁-915₃ are shown for Access Group Card 900_{1A}. Each of the Access Group Cards 900 also has sixteen Routing Control Outputs 927₁-927₁₆, which are used in pairs, as explained above. For illustrative simplicity, the Routing Control Outputs of the Access Group Cards are not labeled in FIG. 12. Control Interconnections Paths, which are also not labeled, but shown as lines with arrows, interconnect Routing Control Outputs to Plane Switching Cards. In Matrix Switching Planes 865 have four Rank One Plane Switching Cards 800_{R1G1}, 800_{R1G2}, 800_{R1G3}, 800_{R1G4} and four Rank Two Plane Switching Cards 800_{R2G1}, 800_{R2G2}, 800_{R2G3}, 800_{R2G4}. Similarly, Out Matrix Switching Planes 865′ have four Rank One Plane Switching Cards 800′_{R1G1}, 800′_{R1G2}, 800′_{R1G3}, 800′_{R1G4} and four Rank Two Plane Switching Cards 800 ′_{R2G1}, 800′_{R2G2}, 800′_{R2G3}, 800′_{R2G4}.

Table 1 shows a Control Interconnectivity Map, which corresponds to the Control Interconnection Pattern of a One Unit System that is shown in FIG. 12. At the initial installation of a Re-Arrangeable Analog Electrical Cross Connect it may be expected that the number of subscribers to be served will be much less than the ultimate capacity of the full equipment. In order to conserve capital outlay, a subset of the total equipment may be installed, and added to in two stages as the number of subscribers increases to the point that the subset installed is inadequate for the traffic.

TABLE 1
Control Interconnectivity Map

| | | | Stage | | | | | | | |
|---|---|---|---|---|---|---|---|---|---|---|
| | | | 1 | 1 | 1 | 1 | 2 | 2 | 2 | 2 |
| Stage | Direction | Identifier | 900_{1A} | 900_{1B} | 900_{2A} | 900_{2B} | 900_{3A} | 900_{3B} | 900_{4A} | 900_{4B} |
| 1 | IN | 800_{R1G1} | 1 | 1 | 1 | | | | | |
| 1 | IN | 800_{R2G1} | 1 | 1 | 1 | | | | | |
| 1 | IN | 800_{R1G2} | 1 | 1 | 1 | | | | | |
| 1 | IN | 800_{R2G2} | 1 | 1 | 1 | | | | | |
| 2 | IN | 800_{R1G3} | | | | | 2 | 2 | 2 | |
| 1 | IN | 800_{R2G3} | | 1 | 1 | 1 | | | | |
| 3 | IN | 800_{R1G4} | | | | | 3 | 3 | 3 | |
| 2 | IN | 800_{R2G4} | | | | | 2 | 2 | 2 | |
| 1 | OUT | 800_{R1G1} | 1 | 1 | | 1 | | | | |
| 1 | OUT | 800′_{R2G1} | 1 | 1 | | 1 | | | | |
| 1 | OUT | 800′_{R1G2} | 1 | | 1 | 1 | | | | |
| 1 | OUT | 800′_{R2G2} | 1 | | 1 | 1 | | | | |
| 2 | OUT | 800′_{R1G3} | | | | | 2 | 2 | 2 | |
| 1 | OUT | 800′_{R2G3} | | 1 | 1 | 1 | | | | |
| 3 | OUT | 800′_{R1G4} | | | | | 3 | 3 | 3 | |
| 2 | OUT | 800′_{R2G4} | | | | | 2 | 2 | 2 | |

Table 1 shows a connectivity map for the control of these subsets of cards. Numbers in the topmost row identify the stages in which the Access Group Cards are to be added. Numbers in the leftmost column identify the stages in which the Plane Switching Cards are to be added. Numbers in the body of the table identify the stages in which the control interconnections are to be made among cards. If there is no number at an intersection of a Access Group Card's column and a Plane Switching Card's row, then there is no control connection between the two cards. A number at such an intersection identifies the stage in which the control interconnection is made between the cards.

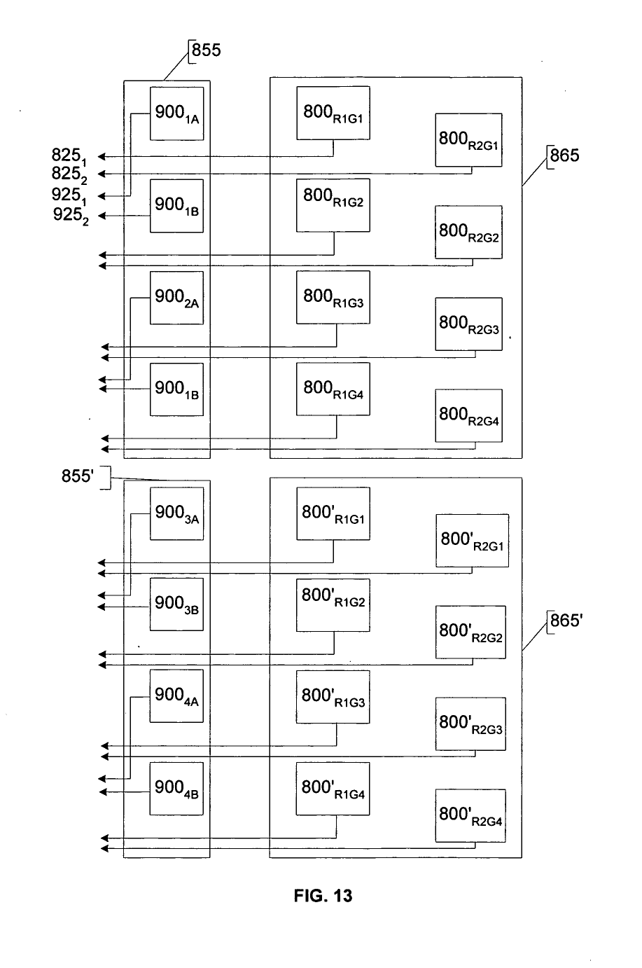

Referring now to FIG. 13, there is shown a Response Interconnection Pattern for a One Unit Matrix, whose Control Interconnection Pattern is show in FIG. 12. Each Access Group Card 900 has a Control Output 925. Only Control Outputs 925₁ and 925₂ are shown for Group One's Access Group Cards 900_{1A} and Cards 900_{1B}, which together comprise a Group One In Access Group Response. Similarly, each Plane Switching Card 800 has a Control Output 825 only Control Outputs 825₁ and 825₂ are shown for Group One's Rank One In Plane Switching Cards 800_{R1G1} and Group One's Rank Two Plane Switching Cards 800_{R1G1}, respectively, which together comprise a Group One In Switching Plane Response. There are similar responses, which are not labeled, for Group One Out Access Group Response and Group One Out Switching Plane Response. There are also similar Response for each of the other four Access Groups.

Cross Connect Control

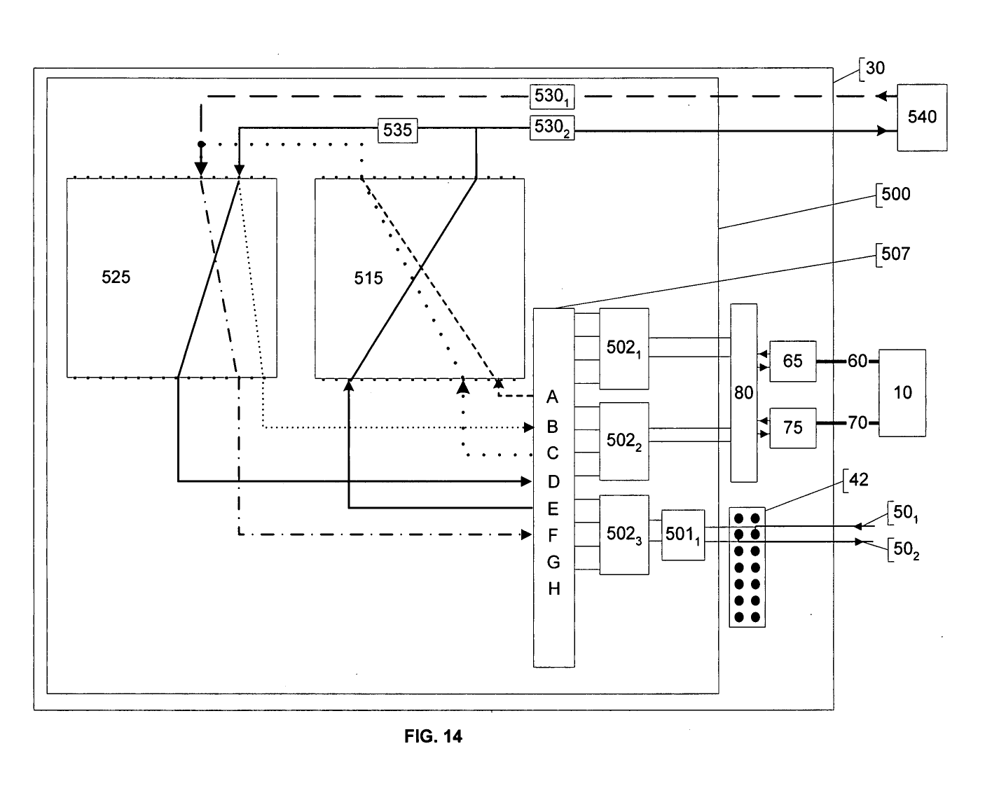

A need can arise for re-routing an existing subscriber connection. It is important to provide continuity of service during the re-routing. A dual path cable throw has been used with traditional copper cross connects to achieve this result. Referring now to FIG. 14, there is shown a “dual path cable throw” using the Re-Arrangeable Analog Electrical Cross Connect 500, whose operation was explained with the discussion of FIG. 7. Assume that the connection paths from points C to F and points E to D have been established as previously explained. The points C and D correspond to a particular trunk line circuit (not shown) that is provided by DLC 80. The points E and F correspond to a subscriber line circuit that is formed by Subscriber Lines 50₁-50₂. The points A and B correspond to another trunk line circuit (not shown) that is provided by DLC 80. Suppose that it is now desirable to connect the trunk line circuit corresponding to points A and B with the subscriber line circuit corresponding to points E and F.

Initially, the connections connection paths from points C to F and points E to D remain unchanged. Commands (not shown) are received by the Re-Arrangeable Analog Electrical Cross Connect 500 that instruct it to start building a dual path to points E and F from points A and B. First, the Out Matrix Switching Planes 525 provide a second connection path from the Input Port that is used for the connection path from points E to D. Second, the In Matrix Switching Planes 515 establish a connection path from the Input Port that is connected to point A to the last stage (not shown) of the In Matrix Switching Planes 515 before the Output Port that is used by the connection path from points C to F. Third, the connection from the last stage (not shown) of the connection path from point C to this Output Port is disconnected, and a new connection is made from the last stage of the connection path from point A to this Output Port. Fourth, the rest of the connection paths from points C and D are disconnected so that they may be used to build other connections paths as required in the future.

When a cabinet begins to reach capacity, it may occur that a particular new connection cannot be made because of existing connections blocking the only path. In this case a suitable path may be made available by re-routing an existing connection within the matrices. This re-routing becomes a special case of the “dual path cable throw”, such that a revised path to the existing subscriber be connected to the existing path at some point within the matrices, to allow an existing voice connection in progress to continue whilst the re-routing takes place. Once the re-routing is complete and tested, the connection to the new subscriber may be routed.

It is intended that all switch Matrix cards will be identical and that their position in the network, and their appropriate behavior for that position will be conditioned by external connections that indicate their position. As can be seen from FIG. 10, each Plane Switching Card 800 three Control Inputs 815₁-815₃, which have come from three different Access Group Cards (not shown). In addition, each Plane Switching Card 800 has three Input Lines 816₀-816₂ that indicate the rank position of the card in a system. Referring now to FIG. 11, Access Group Card 900 has similar Control Inputs 915₁-915₃ and Input Lines 916₀-916₂ indicate the rank position of the card in the system.

A card's position in a network is given by applying an active voltage to one of the Input Lines 916₀-916₂ corresponding to its rank position in the network, and grounding the other two position inputs. This determines its rank, where Access Group Cards 900 are rank zero.

After control signals applied to input control signals, such as Control Inputs 915₁-915₃, which are coded in telephony dual tone numerals, have been decoded into one out of twelve lines, the majority output of these voting inputs is used in three ways. It is used by the controller as one of a sequence of commands. When it is the first in a command sequence, it is used to compare with the Rank Input Lines 916₀-916₂ to identify whether the following command sequence should be used by the controller. It is re-encoded, and sent to the control switching element, where it must be routed either to the rank response line, or to a previously selected next rank control line. If there is a minority value from Voting Circuit 918, its existence must be inserted into the response code stream to alert the Central Office controller of a potential fault condition. The program for a Controller 921 is held in ROM or FLASH memory

A control interconnection pattern is shown on FIG. 12. As previously noted, each Access Group Card 900 receives its Control Inputs 915 from three particular DLC outputs, to provide three input voting redundancy. Thus, with eight Access (half) Groups, twenty-four of the forty-two spare DLC channels are utilized.

A new voice path is set up in a sequence of steps by first setting a path across an Access Group Card 900 that is required, and then setting up the ongoing control path in that card to the first switching stage of an In Matrix interconnection section to be used. To complete the setting of this stage of the voice switching route, the three required Access Group Control chips are set to pass on control signals to a selected Rank One card of the In Matrix interconnection section. In a similar way, the voice path selected is set up stage by stage, by setting up three control paths to each stage in turn in order to pass the necessary control signals to the required controller. The control paths for this mechanism are shown in FIG. 12. The connecting pattern for the response lines is shown in FIG. 13.

TABLE 2
Control Command Sequences

| In | | Rank | | Response |
|---|---|---|---|---|
| Symbol | Meaning | match | Controller action | Symbol |
| * | String start | | | * |
| X (0,2) | Rank number | No | Ignore rest of string | X |
| | | Yes | Note if valid | |
| * | Field end | | Note if minority | */9 |
| Y (0,¼) | 4 means do nothing | | If 4, do nothing | Y |
| Y (0,9) | SE number | | | Y |
| | (17 is loop switch, | | | |
| | 18, 19 invalid) | | | |
| A (0,1) | | | | A |
| A (0,9) | Input port A | | | A |
| | (17, 18, 19 invalid) | | | |
| B (0,1) | | | | B |
| B (0,9) | Output port B | | | B |
| | (17, 18, 19 invalid) | | | |
| C (0/1) | | | Connect/Disconnect | C |
| | | | A & B in Y | |
| * | Field end | | | */9 |
| D (0,¼) | | | If 4, do nothing | D |
| D (0,9) | Control SE | | | D |
| | input port | | | |
| | (17, 18, 19 invalid) | | | |
| E (0,1) | | | | E |
| E (0,9) | Control SE | | | E |
| | output port | | | |
| | (17, 18, 19 invalid) | | | |
| F (0/1) | | | If valid, | F |
| | | | Connect/Disconnect | |
| | | | D & E | |
| * | Field end | | | */9 |
| G (8,#) | 8 is control SE reset | | If 8 initialize control | G |
| | | | SE | |
| # | End string | | | # |

Note
Initialize = Connect input from Controller to Rank-response
Y identifies a Plane, and X identifies a Rank

Control Command symbols consist of numerals 0 through 9 plus * and #. A value of * will be used as a field delimiter, and a value of # will be used as a command string delimiter. A value 9 will be used as a replacement for * in the response string as a minority error indication. Command field sequences are shown above in Table 2.

Central Office Switch Management

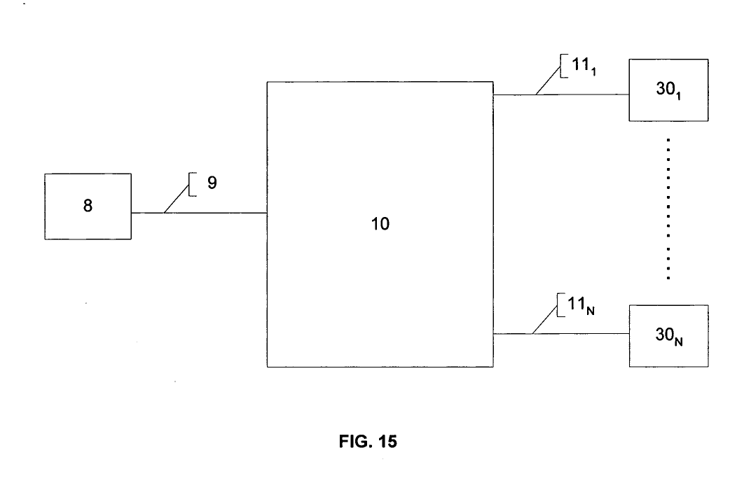

The overall structure of a control path from the Central Office control Terminal and Database to the pedestals is shown in FIG. 15. A Control Terminal Subsystem 8 is connected to a Central Office 10 by means of 24 PCM Control Channels 9. These 24 PCM Control Channels 9 are used to set a path across the Central Office 10 to 24 PCM Control Channels 11 are for a selected pedestal, and setup the connections to receive responses, and verify path continuity. For example, Control Terminal Subsystem 8 uses 24 PCM Control Channels 9 to select 24 PCM Channels 11₁ as a control communications channel from Central Office 10 to Pedestal 30₁. Thereafter, Control Terminal Subsystem 8 will deliver a sequence of control combinations (not shown) to achieve a desired subscriber connection, and test it as described above.

For example, to prove a successful completion of a path across a cross connect to a particular subscriber line circuit (not shown) Control Terminal Subsystem 8 sends Control Commands (not shown) over 24 PCM Control Channels 11₁ to a Pedestal 30₁. A Re-Arrangeable Analog Electrical Cross Connect (not shown) in Pedestal 30₁ closes a loop switch (not shown) to perform loop test on a subscriber's line (not shown), as described above. Control Terminal Subsystem 8 then sends a test signal to the subscriber's line and its return is verified. Control Terminal Subsystem 8 then sends Control Commands (not shown) to cause the loop switch to return to its normally open state.

The Control Terminal Subsystem 8 uses algorithms to determine the most efficient path across an In Matrix (not shown) and an Out Matrix (not shown) for setting up a required connection path. This applies to both the voice paths and the DSL and television paths and their interlinking.

Where existing connections are to be re-routed, it is important that the revised connection be set up and linked to the first connection before the first connection is destroyed. This must be achieved in a way that ensures that any voice connection in progress at the time of re-routing is not interrupted.

One skilled in the art will appreciate that many changes can be made to the exemplary embodiments disclosed without departing from the spirit of the present invention.

We claim:

1. A system for providing re-arrangeable analog electrical cross connections between a plurality of signal inputs and a plurality of signal outputs, wherein the re-arrangeable analog electrical cross connections are achieved by a plurality of interconnected solid-state electronic switching components.

2. A system as described in claim 1, having
at least one input signaling unit comprised of
an input signaling unit input,
an input signaling unit output, which is connected to one of the signal inputs,
a high-voltage signal detector, which is internally connected to the input signaling input, and
a low-voltage signal generator, which is internally connected to the input signaling unit output,
wherein upon activation of the high-voltage signal detector the input signaling unit input is switched to a high-impedance state and the low-voltage signal generator provides a low-voltage signal to the input protection unit output; and
at least one output signaling unit comprised of
an output signaling unit input, which is connected to one of the signal outputs,
an output signaling unit output,
a low voltage signal detector, which has an internal connection to the output signaling unit input, and
a high-voltage ringing signal generator, which has an internal connection to the input signaling output,
wherein upon activation of the low voltage signal detector the high-voltage signal generator provides a high-voltage ringing signal to the output signaling unit output.

3. A system as described in claim 1, having at least one signal amplification or regeneration unit that is connected to one of the signal outputs or one of the signal inputs.

4. A system as described in claim 3, wherein at least one signal amplification or regeneration unit has a DSL signal amplification or regeneration circuit, which amplifies or regenerates DSL signals.

5. A system as described in claim 3, wherein at least one signal amplification or regeneration unit has a television signal amplification or regeneration circuit, which amplifies or regenerates television signals.

6. A system as described in claim 1, having a DLC communications interface connected to at least one of the signal inputs and at least one of the signal outputs.

7. A system for providing re-arrangeable analog electrical cross connections between a plurality of signal inputs and a plurality of signal outputs, wherein the re-arrangeable analog electrical cross connections are provided by a plurality of interconnected printed circuit cards, wherein each printed circuit card is comprised of one or more solid-state electronic switching components, a local control element, and a control element input circuit for processing re-arrangement directives.

8. A system as described in claim 7, wherein at least one control element input circuit has at least one DTMF tone decoder for decoding incoming re-arrangement directives.

9. A system as described in claim 8, wherein at least one control element input circuit has at least one DTMF tone encoder for encoding outgoing responses.

10. A system as described in claim 7, wherein at least one printed circuit card has a plurality of controllable loopback switches and a plurality of subscriber line interfaces, wherein each subscriber line interface has a first connector and a second connector; wherein each loopback switch provides a selectable connection between the first connector and the second connector of one of the subscriber line interfaces; and wherein each loopback switch is controlled by the local control element.

11. A system as described in claim 7, wherein each control element input circuit is further comprised of a voting circuit that compares a plurality of control signals on a plurality of control inputs, wherein a majority control signal, which the voting circuit determines exists on a majority of the control inputs, is provided to the local control element.

12. A system as described in claim 11, wherein each voting circuit has a minority output, which is activated if the voting circuit determines that all of the control signals on the control inputs do not match.

13. A system as described in claim 11, wherein the control inputs of each voting circuit are connected to a different source of re-arrangement directives.

14. A system as described in claim 13, wherein three of the printed circuit cards each have a control output connected to a different one of the control inputs of a fourth printed circuit card.

15. A system as described in claim 7, wherein one or more of the re-arrangement directives indicate that subsequently received re-arrangement directives are to be forwarded to a specified local control element.

16. A system as described in claim 9, wherein the re-arrangement directives are voice band signals.

17. A system as described in claim 16, wherein the re-arrangement directives are comprised of sequences of dual tone numerical and symbol signals.

18. A system as described in claim 9, wherein each printed circuit card is further comprised of a plurality of rank location inputs; wherein the local control element determines a rank location assignment based on voltages that are applied to the rank location inputs.

19. A system as described in claim 18, wherein the re-arrangement directives contain a rank location indication and a re-arrangement command; wherein the local control element executes the re-arrangement command only if the rank location indication equals the rank location assignment.

20. A system as described in claim 10, wherein one or more re-arrangement directives contain a loopback command; wherein the local control element selects one of the loopback switches based on the loopback command.

21. A system for providing re-arrangeable analog electrical cross connections between a plurality of signal inputs and a plurality of signal outputs, wherein the re-arrangeable analog electrical cross connections are achieved by a plurality of solid-state electronic switching components, which are interconnected to provide re-arrangeable analog electrical cross connections between any one of the of the plurality of signal inputs and any one or more of the plurality of signal outputs.

22. A system according to claim 21, wherein a first re-arrangeable analog electrical cross connection is provided between a first signal input and a signal merging point; a second signal input is connected to the signal merging point, and a second re-arrangeable analog electrical cross connection is provided between the signal merging point and a first signal output.

23. A system according to claim 21, wherein a first re-arrangeable analog electrical cross connection is provided between a first signal input and a signal merging point; a second signal input is connected to an input of a high pass filter; an output of the high pass filter is connected to the signal merging point, and a second re-arrangeable analog electrical cross connection is provided between the signal merging point and a first signal output.

24. A system according to claim 21, wherein a first re-arrangeable analog electrical cross connection is provided between a first signal input and a signal splitting point; a second analog electrical cross connection is provided between the signal splitting point and a first signal output; and the signal splitting point has a connection to a second signal output.

25. A system according to claim 21, wherein a first re-arrangeable analog electrical cross connection is provided between a first signal input and a signal splitting point; the signal splitting point has a connection to an input of a low pass filter; a second analog electrical cross connection is provided between an output of the low pass filter and a first signal output; and the signal splitting point has a connection to a second signal output.

26. A system according to claim 21, wherein a first re-arrangeable analog electrical cross connection is provided between a first signal input and a signal splitting point; the signal splitting point has a connection to an input of a low pass filter; a second analog electrical cross connection is provided between an output of the low pass filter and a first signal output; the signal splitting point has a connection to an input of a high pass filter; and an output of the high pass filter is connected to a second signal output.

27. A system according to claim 21, having at least one signal amplification or regeneration unit that is connected to at least one of the signal outputs or at least one of the signal inputs.

28. A system as described in claim 27, wherein at least one signal amplification or regeneration unit has a DSL signal amplification or regeneration circuit, which amplifies or regenerates DSL signals.

29. A system as described in claim 27, wherein at least one signal amplification or regeneration unit has a television signal amplification or regeneration circuit, which amplifies or regenerates television signals.

30. A system for providing re-arrangeable analog electrical cross connections between a plurality of signal inputs and a plurality of signal outputs, wherein the re-arrangeable analog electrical cross connections are achieved by a multi-stage switching network, which is comprised of a plurality of interconnected solid-state electronic switching components.

31. A system as described in claim 30, wherein the multi-stage switching network is comprised of a input switching matrix, which has a plurality of input matrix inputs and a plurality of input matrix outputs; and an output switching matrix, which has a plurality of output matrix inputs and a plurality of output matrix outputs; wherein at least one of the input matrix outputs is ultimately connected to one or more of the output matrix inputs.

32. A system as described in claim 31, wherein a first input matrix input has a first re-arrangeable analog connection to a first input matrix output; the first input matrix output is connected to a first output matrix input; and the first output matrix input has a second re-arrangeable analog connection to a first output matrix output.

33. A system as described in claim 31, wherein at least one of the input matrix outputs has a first connection to an input of a low pass filter and a second connection to a high pass filter; and an output of the low pass filter is connected to one of the output matrix inputs.

34. A system as described in claim 31, wherein at least one of the output matrix inputs has a first connection to an output of a high pass filter and a second connection to one of the input matrix outputs.

35. A system as described in claim 31, wherein the input switching matrix and the output switching matrix are each comprised of an access stage, which has a plurality of access stage inputs and access stage outputs; and a mixing stage, which has a plurality of mixing stage inputs and a plurality of mixing stage outputs.

36. A system as described in claim 35, wherein one or more of the input switching matrix access stage inputs are connected each to one of the signal inputs and one or more of the input switching matrix access stage outputs are connected each to one of the input switching matrix mixing stage inputs; and one or more of the output switching matrix access stage inputs are connected each to one of the output switching matrix mixing stage outputs and one or more of the output switching matrix access stage outputs are connected each to one of the signal outputs.

37. A system as described in claim 35, wherein each of the mixing stages is comprised of a plurality of independent and identically arranged switching planes, wherein each switching plane has a plurality of switching plane inputs and a plurality of switching plane outputs.

38. A system as described in claim 36, wherein each of the switching planes is comprised of one or more ranks of analog semiconductor switching elements; wherein each of the access stages is comprised of a plurality of rank zero analog semiconductor switching elements; each of the plurality of switching planes of the mixing stages is comprised of a plurality of rank one analog semiconductor switching elements; wherein each of the rank zero analog semiconductor switching elements of the input switching matrix access stage has a connection to a group of rank one analog semiconductor switching elements of the input switching matrix mixing stage wherein each member of the group is in a different switching plane; and wherein each of the rank zero analog semiconductor switching elements of the output switching matrix access stage has a connection to a group of rank one analog semiconductor switching elements of the output switching matrix mixing stage, wherein each member of the group is in a different switching plane.

39. A system as described in claim 36, wherein the input switching matrix access stage has a selectable connection to each of the switching planes of the input switching matrix mixing stage; and the output switching matrix access stage has a selectable connection to each of the switching planes of the output switching matrix mixing stage.

40. A system as described in claim 38, wherein each of the switching planes is further comprised of a plurality of rank two analog semiconductor switching elements; wherein within each of the switching planes each rank one analog semiconductor switching element is fully interconnected with each rank two analog semiconductor switching element.

41. A system as described in claim 37, wherein the switching plane outputs of each of the switching planes of the input switching matrix mixing stage are ultimately connected to corresponding switching plane inputs of a corresponding switching plane of the output switching matrix mixing stage.

42. A system as described in claim 38, wherein one of the analog semiconductor switching elements of one of the ranks of analog semiconductor switching elements of each of the switching planes of one of the multi-stage switching matrix mixing stages is mounted on one of a plurality of printed circuit cards.

43. A system as described in claim 38, wherein the analog semiconductor switching elements of each of the access stages are mounted on one or more access printed circuit cards, wherein an equal number of the analog semiconductor switching elements are connected to input matrix inputs and output matrix outputs; and wherein all of the analog semiconductor switching elements mounted on a particular access printed circuit card are controlled by a local control element that is mounted on the particular access printed circuit card.

44. A system as described in claim 31, wherein a first signal input has a first re-arrangeable analog connection to a first input matrix input, wherein the first input matrix input has a second re-arrangeable analog connection to a first input matrix output; the first input matrix output has a first connection to an input of a first filter and a second connection to an input of a second filter; an output of the first filter is connected to a first output matrix input; the first output matrix input has a third re-arrangeable analog connection to a first output matrix output; and the first output matrix output has a fourth re-arrangeable analog connection to a first signal output.

45. A system as described in claim 31, wherein a first signal input has a first re-arrangeable analog connection to a first input matrix input, wherein the first input matrix input has a second re-arrangeable analog connection to a first input matrix output; the first input matrix output has a first connection to a first output matrix input and an output of a filter is also connected to the first output matrix input; the first output matrix input has a third re-arrangeable analog connection to a first output matrix output; and the first output matrix output has a fourth re-arrangeable analog connection to a first signal output.
